(19) United States
(12) Patent Application Publication
(10) Pub. No.: US 2023/0292776 A1
(43) Pub. Date: Sep. 21, 2023

(54) GAS PHASE TREATMENT OF PRODUCE

(71) Applicant: Apeel Technology, Inc., Goleta, CA (US)

(72) Inventors: Benjamin Gordon, Goleta, CA (US); Matthew Kahlscheuer, Goleta, CA (US); Charles Frazier, Goleta, CA (US); Jessica Sexton, Goleta, CA (US); Anthony Crisci, Goleta, CA (US)

(21) Appl. No.: 18/124,540

(22) Filed: Mar. 21, 2023

Related U.S. Application Data
(60) Provisional application No. 63/486,892, filed on Feb. 24, 2023.
(60) Provisional application No. 63/322,176, filed on Mar. 21, 2022.

(51) Int. Cl. A23B 7/144

(52) U.S. Cl. CPC A23B 7/144

(57) ABSTRACT

A produce treatment method to mitigate latent infections, such as fungal infections, and to delay ripening in produce is described. The produce treatment method includes providing an antimicrobial agent to an enclosure comprising a plurality of produce items, and contacting the plurality of produce items with the antimicrobial agent, wherein the antimicrobial agent is in gaseous form and is selected to deactivate latent microbes in the plurality of produce items.

### CROSS-REFERENCE TO RELATED APPLICATIONS

This application claims the benefit of U.S. Application Ser. No. 63/322,176 entitled “GAS PHASE TREATMENT OF LATENT INFECTION IN PRODUCE” filed Mar. 21, 2022, and U.S. Application Ser. No. 63/486,892 entitled “GAS PHASE TREATMENT OF PRODUCE” filed Feb. 24, 2023, which are incorporated by reference herein in their entirety.

### TECHNICAL FIELD

This disclosure relates to the use of slow release, gas phase treatments to mitigate latent infections, such as fungal infections, and delay ripening in produce. Further, this disclosure relates to edible coating compositions including one or more monoglycerides, one or more fatty acid salts, and allyl isothiocyanate.

### BACKGROUND

Post-harvest food spoilage is a significant factor limiting the storage period and marketing life of produce, resulting in serious economic losses globally. The main causes of these losses are pest or disease infestation or incorrect storage conditions, which lead to rotting or loss of fresh mass due to respiration and evaporation. Unlike the other more common postharvest fungal infections that require a wound for entry in causing rot, latent infections originate before produce is harvested and reside within the produce. Latent infections typically cannot be prevented or mitigated with common surface treatments used for other rot-causing plant pathogens.

Moreover, many common agricultural products, for example avocados and bananas, are typically harvested prior to complete ripening and then allowed to fully ripen post-harvest, for example during storage or shipping. Many of these products are seasonal, and hence only ripen during a limited time window. This typically makes the seasonal agricultural products available to consumers only during that limited time window.

### SUMMARY

This disclosure describes the use of slow release, gas phase treatments to mitigate latent fungal infections and to delay ripening. In some embodiments, bio-fumigation as described herein uses molecules that exist in fruits and vegetables as a natural approach for the management of post-harvest disease of produce. Natural compounds that are reactive or toxic in concentrated forms can be hazardous to transport and handle, as well as difficult to store. Storing these active compounds as stable precursors and converting them to the active forms enzymatically on-site can simplify transportation and handling and increase shelf-life. Enzymatic processes are conducted under mild conditions (close to ambient temperature, atmospheric pressure and physiological pH) with high rates. Enzymatic processes are more environmentally friendly, more cost-effective and, ultimately, more sustainable.

Although the disclosed inventive concepts include those defined in the attached claims, it should be understood that the inventive concepts can also be defined in accordance with the following embodiments.

In addition to the embodiments of the attached claims and the embodiments described above, the following numbered embodiments are also innovative.

Embodiment 1 includes a produce treatment method comprising:
providing an antimicrobial agent to the enclosure; and
contacting the plurality of produce items with the antimicrobial agent, wherein the antimicrobial agent is in gaseous form and is selected to deactivate latent microbes in the plurality of produce items.

Embodiment 2 is the method of embodiment 1, further comprising sealing the enclosure before providing the antimicrobial agent to the enclosure.

Embodiment 3 is the method of embodiments 1 or 2, wherein the enclosure comprises a produce packaging container, a produce storage container, a produce transportation container, or a produce treatment container.

Embodiment 4 is the method of embodiment 3, wherein the produce packaging container comprises a clamshell.

Embodiment 5 is the method of embodiment 3, wherein the produce transportation container comprises a shipping container or a box truck.

Embodiment 6 is the method of embodiment 3, wherein the produce treatment container comprises a degreening room or a ripening room.

Embodiment 7 is the method of any one of embodiments 2-6, wherein the enclosure is airtight or limits a rate of diffusion of gas into or out of the enclosure.

Embodiment 8 is the method of any one of embodiments 1-7, wherein providing the antimicrobial agent to the enclosure comprises providing a gaseous stream comprising the antimicrobial agent to the enclosure.

Embodiment 9 is the method of embodiment 8, further comprising pumping the gaseous stream into the enclosure.

Embodiment 10 is the method of any one of embodiments 1-9, wherein the length of time is in a range of 1 minute and 100 hours.

Embodiment 11 is the method of embodiment 10, wherein the length of time is in a range of 10 minutes to 1 hour.

Embodiment 12 is the method of any one of embodiments 1-11, further comprising adjusting a temperature or humidity inside the enclosure.

Embodiment 13 is the method of any one of embodiments 1-12, further comprising adjusting a temperature or humidity inside the enclosure.

Embodiment 14 is the method of embodiment 13, wherein volatilizing the antimicrobial agent precursor occurs outside the enclosure.

Embodiment 15 is the method of embodiment 13, wherein volatilizing the antimicrobial agent precursor occurs inside the enclosure.

Embodiment 16 is the method of any one of embodiments 1-15, further comprising activating an antimicrobial agent precursor to yield the antimicrobial agent.

Embodiment 17 is the method of embodiment 16, wherein activating the antimicrobial agent precursor comprises contacting the antimicrobial agent precursor with a catalyst selected to facilitate conversion of the antimicrobial agent precursor to antimicrobial agent.

Embodiment 18 is the method of embodiment 17, wherein the catalyst is a biocatalyst.

Embodiment 19 is the method of embodiment 18, wherein the biocatalyst is an enzyme.

Embodiment 20 is the method of embodiment 19, wherein the antimicrobial agent precursor comprises alliin, the enzyme comprises alliinase, and the antimicrobial agent comprises allicin.

Embodiment 21 is the method of embodiment 19, wherein the antimicrobial agent comprises sinigrin, the enzyme comprises myrosinase, and the antimicrobial agent comprises allyl isothiocyanate.

Embodiment 22 is the method of any one of embodiments 1-21, wherein providing the antimicrobial agent to the enclosure comprises:
providing an antimicrobial agent precursor to a reactor, wherein the reactor comprises a catalyst selected to facilitate conversion of the antimicrobial agent precursor to the antimicrobial agent;
flowing a carrier gas from a first end of the reactor toward a second end of the reactor, thereby forming a gaseous mixture comprising the carrier gas and the antimicrobial agent; and
directing the gaseous mixture from the second end of the fixed bed reactor to the enclosure.

Embodiment 23 is the method of embodiment 22, wherein providing the antimicrobial agent precursor to the reactor comprises pumping the antimicrobial agent precursor toward the reactor.

Embodiment 24 is the method of embodiment 23, wherein flowing the gas from the first end of the reactor to the second end of the reactor comprises forcing the gas from the first end of the reactor toward the second end of the reactor.

Embodiment 25 is the method of embodiment 24, wherein the reactor is a fixed bed reactor.

Embodiment 26 is the method of embodiment 24, wherein the catalyst comprises an enzyme.

Embodiment 27 is the method of any one of embodiments 1-26, wherein contacting the plurality of produce items with the antimicrobial agent comprises circulating the antimicrobial agent in the enclosure.

Embodiment 28 is the method of any one of embodiments 1-27, wherein contacting the plurality of produce items with the antimicrobial agent comprises permeating a cuticular layer of each of the plurality of produce items with the antimicrobial agent.

Embodiment 29 is the method of any one of embodiments 1-28, wherein the antimicrobial agent comprises one or more of an antibacterial agent, an antifungal agent, and an antiviral agent.

Embodiment 30 is the method of embodiment 29, wherein the antimicrobial agent comprises an antifungal agent.

Embodiment 31 is the method of embodiment 30, wherein the antifungal agent comprises allyl isothiocyanate, diallyl disulfide, carvacrol, eugenol, cinnamaldehyde, limonene, thymol, methyl anthranilate, methyl cinnamate, gamma-decalactone, alpha-terpineol, linalool, or any combination thereof.

Embodiment 32 is the method of embodiment 30, wherein the antifungal agent comprises a derivative of cis-3-hexene.

Embodiment 33 is the method of embodiment 32, wherein the antifungal agent comprises cis-3-hexenol or cis-3-hexenyl acetate.

Embodiment 34 is the method of any one of embodiments 30-33, wherein the antifungal agent is selected to deactivate green mold or blue mold.

Embodiment 35 is the method of any one of embodiments 30-34, wherein the antifungal agent is selected to deactivate Botrytis cinerea, Penicillium spp., Monihnia spp., Alternaria alternata, Rhizopus stolonifera, Trichothecium roseum, Fusarium spp., Colletotrichum spp., or any combination thereof.

Embodiment 36 is the method of any one of embodiments 1-35, wherein the plurality of produce items comprises fruits, vegetables, or a combination thereof.

Embodiment 37 is the method of embodiment 36, wherein the plurality of produce items comprises fruit.

Embodiment 38 is the method of embodiment 37, wherein the fruit comprises berries (e.g., avocado, banana, blueberry, cranberry, eggplant, tomato, grapes, persimmon), hesperidium (e.g., oranges, lemons, limes, grapefruit, kumquat), pepo (e.g., pumpkin, cucumber, watermelon), drupe (e.g., peaches, plums, cherries, olives), pomes (e.g., apples, pears), aggregate fruits (e.g., blackberry, raspberry), and accessory fruits (e.g., strawberry).

Embodiment 39 is the method of any one of embodiments 1-38, further comprising positioning the plurality of produce items in the enclosure before providing the antimicrobial agent to the enclosure.

Embodiment 40 is the method of any one of embodiments 1-39, further comprising, after contacting the plurality of produce items with the antimicrobial agent for a length of time, removing the plurality of produce items from the enclosure to yield a plurality of treated produce items.

Embodiment 41 is the method of any one of embodiments 1-40, wherein the antimicrobial agent comprises allyl isothiocyanate.

Embodiments 42 is the method of any one of embodiments 1-41, wherein the antimicrobial agent comprises allyl isothiocyanate and one or more antimicrobial agents selected from the group of: diallyl disulfide, carvacrol, eugenol, cinnamaldehyde, limonene, thymol, methyl anthranilate, methyl cinnamate, gamma-decalactone, alpha-terpineol, and linalool.

Embodiment 43 is the method of embodiment 41 or 42, wherein the antimicrobial agent is provided to the enclosure in a concentration of at least 0.1 ppmv, at least 1 ppmv, at least 10 ppmv, at least 100 ppmv, at least 1000 ppmv, at least about 1200 ppmv, at least about 1250 ppmv, or about 0.1 ppmv to about 4900 ppmv, or about 1250 ppmv to about 5000 ppmv, or about 1250 ppmv to about 4900 ppmv.

Embodiment 44 is the method of embodiment 38, wherein the fruit is avocado, strawberry, mandarin, or lemon.

Embodiment 45 is the method of any one of embodiments 1-44 further comprising coating the plurality of produce items with an edible coating composition.

Embodiment 46 is the method of embodiment 45, wherein the edible coating composition comprises:
a coating agent comprising one or more saturated glycerides selected from monoglycerides and diglycerides; and one or more fatty acid salts; and
a solvent.

Embodiment 47 is the method of embodiment 46, wherein the one or more saturated glycerides is present in the coating agent in an amount of about 75 wt % to about 98 wt %, about 80 wt % to about 98 wt %, or 85 wt % to about 98 wt %, or about 90 wt % to about 98 wt %, or about 92 wt % to about 97 wt %, or about 95 wt %.

Embodiment 48 is the method of embodiment 46 or 47, wherein the one or more fatty acid salts is present in the coating agent in an amount of about 1 wt % to about 20 wt %, or about 1 wt % to about 15 wt %, or about 1 wt % to about 12 wt %, 2 wt % to about 8 wt %, or about 3 wt % to about 7 wt %, or about 5 wt %.

Embodiment 49 is the method of any one of embodiments 46-48 wherein each of the one or more saturated monoglycerides comprises a carbon chain length of about C10 to about C22.

Embodiment 50 is the method of any one of embodiments 46-49, wherein one of the one or more saturated monoglycerides is glyceryl monostearate.

Embodiment 51 is the method of any one of embodiments 46-50, wherein each of the one or more fatty acid salts comprises a carbon chain length of about C10 to about C22.

Embodiment 52 is the method of any one of embodiments 46-51, wherein one of the fatty acid salts is sodium stearate.

Embodiment 53 is the method of any one of embodiments 46-52, wherein the coating agent further comprises one or more antimicrobial agents, wherein the one or more antimicrobial agents are selected from diallyl disulfide, carvacrol, eugenol, cinnamaldehyde, limonene, thymol, methyl anthranilate, methyl cinnamate, gamma-decalactone, alpha-terpineol, linalool, cis-3-hexenol or cis-3-hexenyl acetate, sodium benzoate, potassium sorbate, chalcone, fludioxonil, 2-hydroxychalcone, 4-hydroxychalcone, 4′-hydroxychalcone, 2,2′-dihydroxychalcone, 2,4′-dihydroxychalcone, 2′,4-dihydroxychalcone, 2′,4′-dihydroxychalcone, 2′,4,4′-trihydroxychalcone, 2′,4,4′-trihydroxychalcone Intermediate, violastyrene, obtusaquinone, apiole, piperine, celastrol, arthonoic acid, leoidin, antimycin A, antimycin A1, diffractaic acid, ethyl orsellinate, methyl orsellinate, mycophenolic acid, ethyl dichloroorsellinate, angolensin, isocotoin, eupatoriochromene, xanthoxylin, usnic acid, aloin, ononetin, apocynin, isopomiferin, deoxysappanone B 7,4′-dimethyl ether, chrysin dimethyl ether, bergapten, gambogic acid, 2-hydroxyxanthone, isopimpinellin, xanthyletin, acetyl hymetochrome, nobiletin, hymechrome, methoxsalen, 4-methylesculetin, tangeritin, khellin, flavone, 3,4′,5,6,7-pentamethoxyflavone, deguelin(-), citropten, deoxysappanone B trimethyl ether, deoxysappanone B 7,3′-dimethyl ether, 2′,4′-dihydroxy-4-methoxychalcone, daunorubicin hydrochloride, plumbagin, menadione, thymoquinone, levomenthol, methyl trimethoxycinnamate, chavicol, cinnamylphenol, benzoate, napthoquinone, phenone, acetophenone, benzophenone, phenylacetophenone, chitosan, salicylic acid, and sodium salicylate.

Embodiment 54 is a produce treatment system comprising:

a reactor configured to facilitate conversion of an antimicrobial agent precursor to an antimicrobial agent, wherein the reactor comprises:
a bed configured to contain particulate media to which a catalyst is coupled, wherein the catalyst is selected to facilitate conversion of the antimicrobial agent precursor to the antimicrobial agent;
an inlet proximate a first end of the bed and configured to direct a carrier gas from a first end of the bed to a second end of the bed;
an additional inlet configured to direct the antimicrobial agent precursor to the bed; and
an outlet proximate a second end of the bed and configured to allow egress of a gaseous mixture comprising the carrier gas and the antimicrobial agent; and
an enclosure fluidly coupled to the reactor through the outlet, wherein the enclosure is configured to accept a plurality of produce items and to contain the gaseous mixture in contact with the plurality of produce items.

Embodiment 55 is the produce treatment system of embodiment 54, wherein the reactor comprises a fixed bed reactor.

Embodiment 56 is the produce treatment system of embodiments 54 or 55, further comprising a pump in fluid communication with the additional inlet and configured to provide the antimicrobial agent precursor to the reactor.

Embodiment 57 is the produce treatment system of embodiment 56, wherein the pump is a peristaltic pump.

Embodiment 58 is the produce treatment system of any one of embodiments 54-57, wherein carrier gas provided to the inlet volatilizes the antimicrobial agent precursor.

Embodiment 59 is a plurality of produce items treated by the method of any one of embodiments 1-53.

Embodiment 60 is the plurality of produce items of embodiment 59, wherein the plurality of produce items have a mass loss factor of at least 1.50, at least 1.6, at least 1.7, at least 1.8, at least 1.9, at least 2.0, or at least 2.5.

Embodiment 61 is the plurality of produce items of embodiment 59 or 60, wherein the plurality of produce items are avocados, strawberries, mandarins, or lemons.

Embodiment 62 is the plurality of produce items of embodiment 61, wherein the plurality of produce items are 30 treated California #60 avocados, and 5 days after the 30 treated California #60 avocados were treated, the 30 treated California #60 avocados have an average shore value of at least 10 shore, at least 15 shore, at least 20 shore, or at least 25 shore greater than the average shore value of 30 untreated California #60 avocados, and wherein at day 0, the 30 treated California #60 avocados have an average shore value of ±10 shore of the 30 untreated California #60 avocados.

Embodiment 63 is a method of improving shelf-life of a plurality of produce items, the method comprising: providing an antimicrobial agent to an enclosure comprising a plurality of produce items; and contacting the plurality of produce items with the antimicrobial agent, wherein the antimicrobial agent is in gaseous form and is selected to deactivate latent microbes in the plurality of produce items.

Embodiment 64 is the method of embodiment 63 further comprising coating the plurality of produce items with an edible coating composition.

Embodiment 65 is a method of delaying ripening of a plurality of produce items, the method comprising: providing an antimicrobial agent to an enclosure comprising a plurality of produce items; and contacting the plurality of produce items with the antimicrobial agent, wherein the antimicrobial agent is in gaseous form and is selected to deactivate latent microbes in the plurality of produce items.

Embodiment 66 is the method of embodiment 65 further comprising coating the plurality of produce items with an edible coating composition.

Embodiment 67 is an edible coating composition comprising: a coating agent comprising: one or more monoglycerides, one or more fatty acid salts, and allyl isothiocyanate; and a solvent.

Embodiment 68 is the composition of embodiment 67, wherein the allyl isothiocyanate is present in the edible coating composition in an amount of about 0.001% v/v to about 5% v/v, or about 0.01% v/v to about 2.5% v/v, or about 0.1% v/v to about 1.5% v/v, or about 0.5% v/v to about 1.5% v/v.

Embodiment 69 is the composition of embodiment 67 or 68, wherein the one or more monoglycerides are present in the coating agent in an amount of about 75 wt % to about 98 wt %, about 80 wt % to about 98 wt %, or 85 wt % to about 98 wt %, or about 90 wt % to about 98 wt %, or about 92 wt % to about 97 wt %, or about 95 wt %.

Embodiment 70 is the composition of any one of embodiments 67-69, wherein the one or more fatty acid salts is present in the coating agent in an amount of about 1 wt % to about 20 wt %, or about 1 wt % to about 15 wt %, or about 1 wt % to about 12 wt %, 2 wt % to about 8 wt %, or about 3 wt % to about 7 wt %, or about 5 wt %.

Embodiment 71 is the composition of any one of embodiments 67-70, wherein each of the one or more monoglycerides comprises a carbon chain length of about C10 to about C22.

Embodiment 72 is the composition of any one of embodiments 67-71, wherein one of the one or more saturated monoglycerides is glyceryl monostearate.

Embodiment 73 is the composition of any one of embodiments 67-72, wherein each of the one or more fatty acid salts comprises a carbon chain length of about C10 to about C20.

Embodiment 74 is the composition of any one of embodiments 67-73, wherein one of the fatty acid salts is sodium stearate.

Embodiment 75 is the composition of any one of embodiments 67-74, wherein the solvent comprises water.

Embodiment 76 is the composition of any one of embodiments 67-75, wherein the coating agent is present in an amount in a range of about 1 g/L to about 150 g/L, or about 10 g/L to about 100 g/L, or about 25 g/L to about 75 g/L, or about 40 g/L to about 60 g/L, or about 45 g/L to about 55 g/L.

Embodiment 77 is a plurality of produce items coated with the edible coating composition of any one of embodiments 67-76.

Embodiment 78 is the plurality of produce items of embodiment 77, wherein the plurality of produce items have a mass loss factor of at least 1.50, at least 1.6, at least 1.7, at least 1.8, or at least 2, or at least 2.5.

Embodiment 79 is the plurality of produce items of embodiment 77 or 78, wherein the plurality of produce items are avocados.

As used herein, the term “antimicrobial” refers to a compound that inhibits growth of microorganisms, including inhibiting growth of bacteria, fungi, and viruses.

As used herein, “fatty acid” is a hydrocarbon chain comprising an ester, acid, or carboxylate group, collectively referred to as “oxycarbonyl moieties”, bonded to one terminus of the hydrocarbon chain, understood to be the “hydrophilic” end; while the opposite terminus is understood to be the “hydrophobic” end. Fatty acids include fatty acids, fatty acid esters (e.g., monoglycerides, diglycerides), and fatty acid salts. As used herein, the term “glyceride” refers to an ester formed from a glycerol and at least one fatty acid, and is a fatty acid derivative.

As used herein, a monoglyceride having a carbon chain length of, for example, about C10 to about C22, refers to the lipophilic portion of the monoglyceride having about 10 carbon atoms to about 22 carbon atoms. For example, a C18 monoglyceride would include glyceryl monostearate because the lipophilic portion of the molecule (e.g., monostearate) has a carbon chain length of 18 carbon atoms, e.g., (C₁₈H₃₅O)—.

As used herein, “glyceryl” refers to a propyl radical substituted with a hydroxyl at each of the two carbon atoms that the radical is not centered on. In some embodiments, a glyceryl is 1-glyceryl (i.e., —CH₂CH(OH)CH₂OH). In some embodiments, a glyceryl is 2-glyceryl (i.e., —CH(CH₂OH)CH₂OH).

The term “mass loss rate” refers to the rate at which the product loses mass (e.g. by releasing water and other volatile compounds). The mass loss rate is typically expressed as a percentage of the original mass per unit time (e.g. percent per day).

The term “mass loss factor” refers to the ratio of the average mass loss rate of uncoated produce (measured for a control group) to the average mass loss rate of the corresponding tested produce (e.g., coated produce) over a given time. Hence a larger mass loss factor for a coated produce corresponds to a greater reduction in average mass loss rate for the coated produce.

The term “% by weight” or “percent by weight” refers to the percentage the identified components or components represent with the percent calculated as percent by weight of all components excluding water, unless otherwise noted.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 is a flowchart showing steps in an embodiment of a produce treatment method.

FIG. 2 is a schematic diagram showing an embodiment of a system for gas phase treatment of latent infection in produce.

FIG. 3 is a graph of the incidence of infection among mandarins that were tested for antifungal activity of diallyl disulfide (DADS) vapor against Penicillium digitatum (Pd).

FIG. 4 is a graph of the incidence of infection among mandarins that were tested for antifungal activity of allyl isothiocyanate (AITC) and DADS vapor against Pd and Penicillium italicum (Pi).

FIG. 5 is a graph of the incidence of infection among mandarins that were tested for the antifungal activity of a reduced dose of AITC vapor against Pd.

FIG. 6 is a graph of the incidence of infection among mandarins that were tested for the antifungal activity of a range of AITC vapor concentrations against Pd.

FIG. 7 is a graph of the incidence of infection among mandarins that were tested for the antifungal activity of a range of AITC vapor exposure times against Pd.

FIG. 8 is a graph of the incidence of infection among mandarins that were tested for the antifungal activity of AITC vapor against Pd with a range of pre-treatment incubation times.

FIG. 9 is a graph of the incidence of infection among avocados that were tested for the antifungal activity of AITC and DADS vapor against Colletotrichum gloeosporioides (Cg).

FIG. 10 is a graph of the incidence of infection among avocados that were tested for the antifungal activity of a range of DADS vapor exposure times against Cg.

FIG. 11 is a graph of the incidence of infection among avocados that were tested for the antifungal activity of a range of AITC and carvacrol vapor exposure times against Cg.

FIG. 12 is a graph of the durometer shore results among avocados that were tested for the antifungal activity of a range of AITC and carvacrol vapor exposure times against Cg.

FIG. 13 is a graph of the incidence of infection among avocados that were tested for the antifungal activity of a range of AITC vapor exposure times against Cg.

FIG. 14 is a graph of the durometer shore results among avocados that were tested for the antifungal activity of a range of AITC vapor exposure times against Cg.

FIG. 15 is an image of an avocado half exposed to the vapor of 500 μL of AITC.

FIG. 16 is a schematic of the enzyme pathway related to a hypothesis for the thickening of avocado peel following exposure to AITC vapor.

FIG. 17 is a graph of the incidence of infection among grapes that were tested for the antifungal activity of AITC and DADS vapor against Botrytis cinerea (Bc).

FIG. 18 is a graph of the incidence of infection among strawberries that were tested for the antifungal activity of AITC vapor against Bc.

FIG. 19 is a graph of the incidence of infection among two test groups of strawberries that were tested for the antifungal activity of a range of AITC vapor concentrations against Bc.

FIG. 20 is a graph of the incidence of infection among strawberries that were tested for the antifungal activity of AITC vapor under different exposure conditions against Bc.

FIG. 21 is a graph of the incidence of infection among strawberries that were treated with a coating agent and tested for the antifungal activity of AITC vapor against Bc.

FIG. 22 is a graph of the mass loss factor (MLF) results of strawberries suspended, treated with a coating agent, and tested for the antifungal activity of AITC against Bc.

FIG. 23 is a graph of the percent mold measured for strawberries suspended, treated with a coating agent, and tested for the antifungal activity of AITC against Bc.

FIG. 24 is a graph of the incidence of infection among mandarins that were tested for the antifungal activity of AITC vapors in combination with cis-3-hexen-1-ol (c3H) vapor against Pd.

FIGS. 25A-25E is a graph of the incidence of infection among mandarins that were tested for the antifungal activity of AITC in combination with c3H and essential oils vapors against Pd.

FIG. 26 is a graph of the normalized mean severity of lemon disks tested for the antifungal activity of AITC, c3H and cis-3-hexenyl acetate vapors against Pd.

FIG. 27 is a graph of the firmness of avocados tested for ripening characteristics following AITC vapor exposure, following being coated by an edible coating composition, following AITC vapor exposure and being coated by an edible coating composition, and a group of untreated avocados.

FIG. 28 is a graph of the durometer shore results for four avocado test groups after 5 days, infected with Cg.

FIG. 29 is a graph of the durometer shore of avocados tested for ripening characteristics, durometer shore, following AITC vapor exposure and infected with Cg after 5 days.

### DETAILED DESCRIPTION

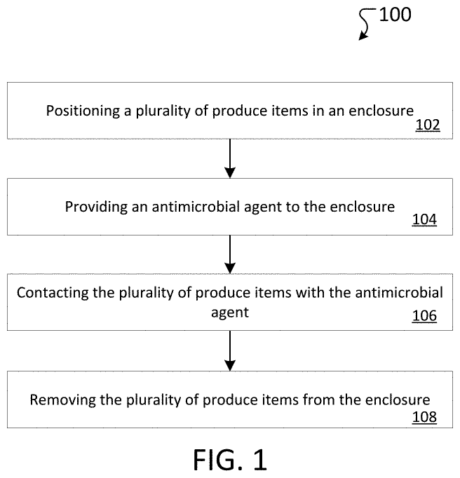

This disclosure describes slow release, gas phase treatments to mitigate latent infections, such as fungal infections, in produce. FIG. 1 is a flowchart showing steps in an embodiment of produce treatment method 100. In 102, a plurality of produce items is positioned in an enclosure. In 104, an antimicrobial agent is provided to the enclosure. In 106, the plurality of produce items is contacted with the antimicrobial agent. The antimicrobial agent is in gaseous form and is selected to deactivate latent microbes in the plurality of produce items. In 108, after contacting the plurality of produce items with the antimicrobial agent for a length of time, the plurality of produce items is removed from the enclosure to yield a plurality of treated produce items.

Provided herein are produce treatment methods comprising providing an antimicrobial agent to an enclosure comprising a plurality of produce items; and contacting the plurality of produce items with the antimicrobial agent, wherein the antimicrobial agent is in gaseous form and is selected to deactivate latent microbes in the plurality of produce items.

There is a need for new, more cost-effective approaches to prevent degradation by microbes, reduce the generation of fungus/mold, maintain quality, and increase the life of agricultural products. Embodiments of the antimicrobial agent or the antimicrobial agent and edible coating composition described herein can provide one or more advantages. For example, in some embodiments, the antimicrobial agent or the antimicrobial agent and edible coating composition can protect the agricultural products from biotic stressors, i.e. bacteria, viruses, fungi, or pests. The antimicrobial agent or the antimicrobial agent and edible coating composition can also prevent evaporation of water and/or diffusion of oxygen, carbon dioxide, and/or ethylene. The antimicrobial agent or the antimicrobial agent and edible coating composition can also help extend the shelf life of agricultural products (e.g., post-harvest produce) without refrigeration. The antimicrobial agent or the antimicrobial agent and edible coating composition can reduce the average mass loss rate for the coated agricultural products. The antimicrobial agent or the antimicrobial agent and edible coating composition can also delay ripening of the agricultural product. The antimicrobial agent or the antimicrobial agent and edible coating composition can also be naturally derived, and hence, safe for human consumption. The produce treatment methods disclosed herein can improve the lifetime of the produce and delay ripening of the produce.

The enclosure can be selected to contain two or more produce items. Examples of suitable enclosures include a produce packaging container (e.g., a clamshell), a produce storage container (e.g., a bin), a produce transportation container (e.g., a shipping container or a box truck), and a produce treatment container (e.g., a degreening room or a ripening room).

Some implementations include sealing the enclosure before providing the antimicrobial agent to the enclosure. Sealing the enclosure can include making the enclosure airtight, or limiting a rate of diffusion of one or more selected gases into or out of the enclosure.

Providing the antimicrobial agent to the enclosure can include providing a gaseous stream comprising the antimicrobial agent to the enclosure. In one example, the gaseous stream comprising the antimicrobial agent is pumped into the enclosure.

The plurality of produce items is contacted with the antimicrobial agent for a length of time in a range of 1 minute to 100 hours (e.g., 10 minutes to 1 hour). The length of time is dependent on a variety of factors, such as type of produce, target pathogen, and the degree to which the enclosure is sealed. Examples include exposure times between 15 minutes and 96 hours for allyl isothiocyanate (AITC) in an airtight bin. For an AITC concentration of 1000 ppm, an exposure time of 15 minutes slowed mold growth on the produce, and an exposure time of 30 min or longer showed good efficacy. Lower antimicrobial agent concentrations with longer exposure times or higher antimicrobial concentrations with shorter exposure times can also be used. For example, the plurality of produce items is contacted with the antimicrobial agent for a length of time in a range of 15 minute to 72 hours.

A concentration of the antimicrobial agent in the headspace of the enclosure is typically in a range of about 20 parts per million by volume (ppmv) to about 5000 ppmv (e.g., about 550 ppmv to about 4800 ppmv, or about 25 ppmv to about 1250 ppmv). Depending on type of produce and exposure time in the enclosure, antimicrobial agent concentrations greater than about 2200 ppmv can sometimes damage the produce. Lower antimicrobial agent concentrations (e.g., 25 ppmv) can be more effective when one of a variety of synergistic effects are present. For AITC concentrations in a range of 550 ppmv to 4800 ppmv, all concentrations had some inhibitory effect on mold growth, and concentrations over 1000 ppmv tended to be completely inhibitory. In some embodiments, the antimicrobial agent is provided in a concentration to the enclosure in a headspace at least about 1200 ppmv, at least about 1250 ppmv, or about 1250 ppmv to about 5000 ppmv, or about 1250 ppmv to about 4900 ppmv.

Some implementations include adjusting a temperature or humidity inside the enclosure. In some implementations, a temperature inside the enclosure is in a range of about 4° C. to about 80° C. (e.g., about 4° C. to about 55° C.), based at least in part on the type of produce to be treated and the antimicrobial agent used. In some implementations, a relative humidity (RH) inside the enclosure is in a range of about 5% to about 99% (e.g., about 30% to about 98%). In some examples, the temperature is in a range of about 18° C. to about 24° C., and a relative humidity (RH) is in a range of about 40% to about 60%. Higher humidity and lower temperatures typically decrease the concentration of passively volatilized gas in the headspace. Antimicrobial agents with lower volatility than AITC and DADS may reach an effective concentration in the enclosure at a temperature greater than 23.33° C. and/or a relative humidity less than 40%.

Exposure time and antimicrobial agent concentration, together with temperature, relative humidity, and other factors, can be selected to optimize antimicrobial performance for the type of produce to be treated and the type of microbe to be deactivated.

In some implementations, an antimicrobial agent precursor is volatilized to yield the antimicrobial agent. Volatilizing the antimicrobial agent precursor can occur outside the enclosure or inside the enclosure.

Some implementations include activating an antimicrobial agent precursor to yield the antimicrobial agent. Activating the antimicrobial agent precursor can include contacting the antimicrobial agent precursor with a catalyst selected to facilitate conversion of the antimicrobial agent precursor to antimicrobial agent. The catalyst can be a biocatalyst (e.g., an enzyme). In one example, the antimicrobial agent precursor comprises alliin, the enzyme comprises alliinase, and the antimicrobial agent comprises allicin. In another example, the antimicrobial agent comprises sinigrin, the enzyme comprises myrosinase, and the antimicrobial agent comprises allyl isothiocyanate.

Contacting the plurality of produce items with the antimicrobial agent can include circulating the antimicrobial agent in the enclosure (e.g., with forced air). Contacting the plurality of produce items with the antimicrobial agent can include permeating a cuticular layer of each of the plurality of produce items with the antimicrobial agent. In some cases, the antimicrobial agent or a derivative thereof can be detected below the cuticular layer of the treated produce up to a certain depth.

Non-limiting antimicrobial agents can include an antibacterial agent, an antifungal agent, an antiviral agent, or any combination thereof. Examples of suitable antifungal agents include allyl isothiocyanate, diallyl disulfide, carvacrol, eugenol, cinnamaldehyde, limonene, thymol, methyl anthranilate, methyl cinnamate, gamma-decalactone, alpha-terpineol, linalool, or any combination thereof. In some cases, the antifungal agent comprises a derivative of cis-3-hexene (e.g., cis-3-hexenol or cis-3-hexenyl acetate). In some embodiments, the antimicrobial agent includes allyl isothiocyanate. The antifungal agent is selected to deactivate green mold or blue mold (e.g., Botrytis cinerea, Penicillium spp., Monihnia spp., Alternaria alternata, Rhizopus stolonifera, Trichothecium roseum, Fusarium spp., Colletotrichum spp., or any combination thereof). In some embodiments the antimicrobial agent is selected to deactivate Colletotrichum spp. (e.g., Colletotrichum gloeosporioides (Cg)).

In some embodiments, the antimicrobial agent includes allyl isothiocyanate and one or more antimicrobial agents selected from the group of diallyl disulfide, carvacrol, eugenol, cinnamaldehyde, limonene, thymol, methyl anthranilate, methyl cinnamate, gamma-decalactone, alpha-terpineol, and linalool.

The plurality of produce items includes fruits, vegetables, or a combination thereof. Examples of suitable fruits include berries (e.g., avocado, banana, blueberry, cranberry, eggplant, tomato, grapes, persimmon), hesperidium (e.g., oranges, lemons, limes, grapefruit, kumquat), pepo (e.g., pumpkin, cucumber, watermelon), drupe (e.g., peaches, plums, cherries, olives), pomes (e.g., apples, pears), aggregate fruits (e.g., blackberry, raspberry), accessory fruits (e.g., strawberry), or any combination thereof. In some embodiments, the fruits are avocados, strawberries, mandarins, or lemons. In some embodiments, the fruits are avocados.

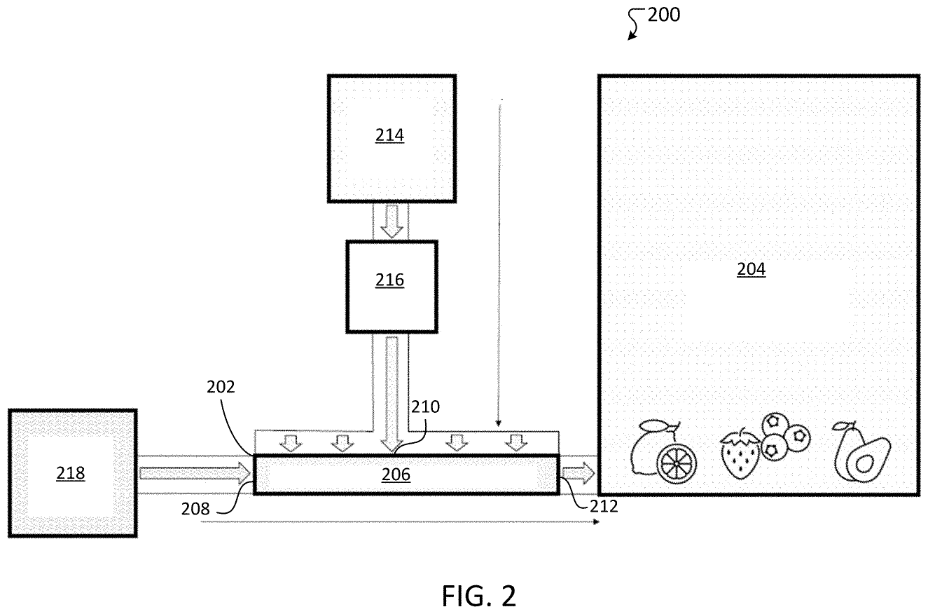

FIG. 2 is a schematic view of an embodiment of system 200 configured to treat produce with a gas phase antimicrobial agent to reduce latent infection. System 200 includes reactor 202 and enclosure 204. Reactor 202 is configured to facilitate conversion of an antimicrobial agent precursor to an antimicrobial agent. Reactor 202 includes bed 206 configured to contain particulate media to which a catalyst selected to facilitate conversion of the antimicrobial agent precursor to the antimicrobial agent is coupled (e.g., covalently or non-covalently bound). In some implementations, reactor 202 is a fixed bed reactor. Inlet 208 is proximate a first end of bed 206 and is configured to direct a carrier gas from the first end of the bed to a second end of the bed. Additional inlet 210 is configured to direct the antimicrobial agent precursor to bed 206. In some implementations, the antimicrobial agent precursor is provided to reactor 202 via pump 212. Outlet 212 is proximate the second end of bed 206 and is configured to allow egress of a gaseous mixture comprising the carrier gas and the antimicrobial agent. Enclosure 204 is configured to be in fluid communication with reactor 202 through outlet 212. The enclosure is configured to accept a plurality of produce items and to contain the gaseous mixture in contact with the plurality of produce items for a length of time. In some implementations, enclosure 204 is an airtight enclosure, such as a bio-fumigation chamber.

Antimicrobial agent precursor in vessel 214 is provided to reactor 202 through pump 216, which is in fluid communication with reactor 202 through additional inlet 210. In one example, pump 216 is a peristaltic pump. Additional inlet 210 can be arranged to provide the antimicrobial agent precursor transverse to a length of bed 206. Catalyst coupled to particulate media in bed 206 converts the antimicrobial agent precursor to a corresponding antimicrobial agent. Carrier gas from source 218 is provided through inlet 208 and flows along a length of bed 206 (e.g., from the first end of bed 206 to the second end of bed 206), volatilizing the antimicrobial agent and forming a gaseous mixture that includes the carrier gas and antimicrobial agent. In some implementations, the carrier gas is a forced air supply provided to reactor 202 as a pressurized gas or as a mechanically forced air supply.

The catalyst in reactor 202 can be a biocatalyst (e.g., an enzyme). In one example, the antimicrobial agent precursor comprises alliin, the enzyme comprises alliinase, and the antimicrobial agent comprises allicin. In another example, the antimicrobial agent comprises sinigrin, the enzyme comprises myrosinase, and the antimicrobial agent comprises allyl isothiocyanate.

In some embodiments, the produce treatment method can further include coating the plurality of produce items with an edible coating composition. Coating the plurality of product items with the edible coating composition can be prior to providing the antimicrobial agent to an enclosure or after contacting the plurality of product items with the antimicrobial agent. The edible coating composition can be coated onto the surface of an agricultural product by means commonly known in the art, e.g., dip-coating. For example, see, e.g., U.S. Patent Publication No. 20190269144 A1, which is incorporated by reference herein in its entirety, for a description of methods of coating agricultural products. The edible coating composition can include a coating agent and a solvent, wherein the coating agent includes one or more saturated glycerides selected from monoglycerides and diglycerides; and one or more fatty acid salts.

In some embodiments, the edible coating composition includes one or more monoglycerides. In some embodiments, the coating agent includes one monoglyceride (e.g., a 1-monoglyceride or a 2-monoglyceride). In some embodiments, the coating agent includes two monoglycerides (e.g., two 1-monoglycerides, two 2-monoglycerides, or one 1-monoglyceride and one 2-monoglyceride). In some embodiments, the coating agent includes three monoglycerides.

In some embodiments, one or more of the monoglycerides has a carbon chain length of about C10 to about C22. In some embodiments, the monoglyceride has a carbon chain length of about C10 to about C22. In some embodiments, the monoglyceride has a carbon chain length that comprises one or more of or is selected from the group consisting of a C10 monoglyceride, a C12 monoglyceride, a C14 monoglyceride, a C16 monoglyceride, a C18 monoglyceride, a C20 monoglyceride, and a C22 monoglyceride. In some embodiments, the monoglyceride is a saturated monoglyceride. In some embodiments, the saturated monoglyceride is monolaurin, glyceryl monostearate, glycerol monostearate, glyceryl monobehenate, glycerol monobehenate, or glyceryl hydroxystearate. In some embodiments, the monoglyceride is glyceryl monostearate.

In some embodiments, the one or more monoglycerides is present in the coating agent in an amount in a range of about 40 wt % to about 99 wt %, based on the total weight of the coating agent. For example, the one or more monoglycerides is present in the coating agent in an amount in a range of about 50 wt % to about 98 wt %, about 60 wt % to about 99 wt %, about 70 wt % to about 98 wt %, about 85 wt % to about 98 wt %, about 90 wt % to about 98 wt %, about 92 wt % to about 97 wt %, or about 95 wt %, based on the total weight of the coating agent. In some embodiments, the one or more monoglycerides is present in the coating agent in an amount in a range of about 75 wt % to about 98 wt %, based on the total weight of the coating agent.

In some embodiments, the edible coating composition includes one or more fatty acid salts. In some embodiments, the coating agent includes one fatty acid salt. In some embodiments, the coating agent includes two fatty acid salts. In some embodiments, the coating agent includes three fatty acid salts. In some embodiments, the coating agent includes four or more fatty acid salts.

In some embodiments, at least one of the one or more fatty acid salts comprises a carbon chain length of about C10 to about C22. In some embodiments, each of the one or more fatty acid salts comprises a carbon chain length of about C10 to about C22. In some embodiments, at least one of the one or more fatty acid salts comprises a carbon chain length selected from the group of: C10, C12, C14, C16, C18, C20, or C22. In some embodiments, each of the one or more fatty acid salts comprises a carbon chain length selected from the group of: C10, C12, C14, C16, C18, C20, or C22. In some embodiments, the one or more fatty acid salts is a C14 fatty acid salt, C16 fatty acid salt, a C18 fatty acid salt, or a combination thereof. In some embodiments, the one or more fatty acid salts is a C16 fatty acid salt, and a C18 fatty acid salt. In some embodiments, one or more of the fatty acid salts is saturated. In some embodiments, one or more of the fatty acid salts is unsaturated.

In some embodiments, one or more of the fatty acid salts is a salt of lauric acid, myristic acid, palmitic acid, stearic acid, archidic acid, behenic acid, lignoceric acid, palmitoleic acid, caprylic acid, capric acid, cerotic acid, oleic acid, linoleic acid, arachidonic acid, eicosapentaenoic acid, docosahexaenoic acid, myristoleic acid, sapienic acid, elaidic acid, vaccenic acid, linoelaidic acid, α-linolenic acid, erucic acid, docosahexaenoic acid, or combinations thereof.

In some embodiments the fatty acid salt comprises one or more of or is selected from the group consisting of sodium laurate, myristate, sodium palmitate, sodium stearate, archidic acid salt, sodium behenate, lignoceric acid sodium salt, sodium arachidonate, eicosapentaenoic acid sodium salt, docosahexaenoic acid sodium salt, sodium myristate, sapienate, elaidate, linoleic acid sodium salt, linoleic acid sodium salt, sodium erucate, and docosahexaenoic acid sodium salt.

In some embodiments, the one or more fatty acid salts is present in the coating agent in an amount in a range of about 1 wt % to about 20 wt %, based on the total weight of the coating agent. For example, the one or more fatty acid salts is present in the coating agent in an amount in a range of about 1 wt % to about 10 wt %, about 1 wt % to about 8 wt %, 1 wt % to about 5 wt %, or about 1 wt % to about 3 wt %, based on the total weight of the coating agent. In some embodiments, the one or more fatty acid salts is present in the coating agent in an amount in a range of about 1 wt % to about 5 wt %, based on the total weight of the coating agent.

In some embodiments, the coating agent comprises one or more monoglycerides in an amount in a range of about 90 wt % to about 98 wt % and one or more fatty acid salts in an amount in a range of about 1 wt % to about 8 wt %. In some embodiments, the coating agent comprises glyceryl monostearate in an amount in a range of about 90 wt % to about 98 wt % and sodium stearate in an amount in a range of about 1 wt % to about 8 wt %.

In some embodiments, the coating agent further comprises an antimicrobial agent as disclosed herein. In some embodiments, the coating agent further comprises one or more antimicrobial agents, wherein the one or more antimicrobial agents are selected from allyl isothiocyanate, diallyl disulfide, carvacrol, eugenol, cinnamaldehyde, limonene, thymol, methyl anthranilate, methyl cinnamate, gamma-decalactone, alpha-terpineol, linalool, cis-3-hexenol or cis-3-hexenyl acetate, sodium benzoate, potassium sorbate, chalcone, fludioxonil, 2-hydroxychalcone, 4-hydroxychalcone, 4′-hydroxychalcone, 2,2′-dihydroxychalcone, 2,4′-dihydroxychalcone, 2′,4-dihydroxychalcone, 2′,4′-dihydroxychalcone, 2′,4,4′-trihydroxychalcone, 2′,4,4′-trihydroxychalcone Intermediate, violastyrene, obtusaquinone, apiole, piperine, celastrol, arthonoic acid, leoidin, antimycin A, antimycin A1, diffractaic acid, ethyl orsellinate, methyl orsellinate, mycophenolic acid, ethyl dichloroorsellinate, angolensin, isocotoin, eupatoriochromene, xanthoxylin, usnic acid, aloin, ononetin, apocynin, isopomiferin, deoxysappanone B 7,4′-dimethyl ether, chrysin dimethyl ether, bergapten, gambogic acid, 2-hydroxyxanthone, isopimpinellin, xanthyletin, acetyl hymetochrome, nobiletin, hymechrome, methoxsalen, 4-methylesculetin, tangeritin, khellin, flavone, 3,4′,5,6,7-pentamethoxyflavone, deguelin(-), citropten, deoxysappanone B trimethyl ether, deoxysappanone B 7,3′-dimethyl ether, 2′,4′-dihydroxy-4-methoxychalcone, daunorubicin hydrochloride, plumbagin, menadione, thymoquinone, levomenthol, methyl trimethoxycinnamate, chavicol, cinnamylphenol, benzoate, napthoquinone, phenone, acetophenone, benzophenone, phenylacetophenone, chitosan, salicylic acid, and sodium salicylate.

In some embodiments, the coating agent can be dissolved, mixed, dispersed, or suspended in a solvent to form a composition (e.g., solution, suspension, or colloid). Examples of solvents that can be used include water, methanol, ethanol, isopropanol, butanol, acetone, ethyl acetate, chloroform, acetonitrile, tetrahydrofuran, diethyl ether, methyl tert-butyl ether, or combinations thereof. For example, the solvent is water. For example, the solvent is ethanol.

In some embodiments, the concentration of the coating agent in the edible coating composition (e.g., solution, suspension, or colloid) is about 1 g/L to 200 g/L. For example, about 1 to 150 g/L, 1 to 100 g/L, 1 to 75 g/L, 1 to 150 g/L, 1 to 50 g/L, 1 to 25 g/L, 10 to 200 g/L, 10 to 150 g/L, 10 to 100 g/L, 10 to 75 g/L, 10 to 50 g/L, 10 to 45 g/L, 10 to 40 g/L, 25 to 75 g/L, 35 to 65 g/L, 40 to 60 g/L, or 45 to 55 g/L.

In some embodiments, any of the edible coating compositions described herein can further comprise one or more additives. In some embodiments, the additive comprises one or more of or is selected from the group consisting of a preservative, a stabilizer, a buffer, a vitamin, a mineral, a pH modifier, a salt, a pigment, a fragrance, an enzyme, a catalyst, an anti-oxidant, an antifungal, an antimicrobial, or a combination thereof.

In some embodiments, the edible coating composition comprises a coating agent comprising one or more monoglycerides in an amount in a range of about 90 wt % to about 98 wt % and one or more fatty acid salts in an amount in a range of about 1 wt % to about 8 wt %, and a solvent, wherein the concentration of the coating agent in the edible coating composition is about 25 g/L to 75 g/L. In some embodiments, the edible coating composition comprises a coating agent comprising glyceryl monostearate in an amount in a range of about 90 wt % to about 98 wt % and sodium stearate in an amount in a range of about 1 wt % to about 8 wt %, and a solvent comprising water, wherein the concentration of the coating agent in the edible coating composition is about 25 g/L to 75 g/L.

Also provided herein is a plurality of produce items treated by the produce treatment methods disclosed herein. When the plurality of produce items is treated by the produce treatment methods disclosed herein, the plurality of produce items can have an increase in the mass loss factor. For example, a plurality of produce items that are not treated by the produce treatment methods disclosed herein have a mass loss factor of 1, but, the plurality of produce items that are treated by the produce treatment methods disclosed herein have a mass loss factor of at least 1.1, or at least 1.5, or at least 1.7, or at least 1.8, or at least 2, or at least 2.2, or at least 2.5, or in a range of 1.1 to 2.8, or in a range of 2 to 2.6. Mass loss, for example, can be measured by determining the difference between the weight of agricultural product after the agricultural product is treated by the produce treatment methods disclosed herein and after a certain period of time passes. In some embodiments, mass loss is measured after 1 day, 2 days, 3 days, 4 days, 5 days, 6 days, 7, days, 8 days, 9 days, and/or 10 days or after any combination thereof. In some embodiments, mass loss is measured after 1 week, after 2 weeks, after 3 weeks, after 4 weeks, after 5 weeks, after 6 weeks, after 7 weeks, after 8 weeks, after 9 weeks, after 10 weeks, after 11 weeks, after 12 weeks, or after any combination thereof Advantageously, the plurality of produce items that are treated by the produce treatment methods disclosed herein have a higher mass loss factor than a plurality of produce items that are untreated.

The plurality of produce items can be at least 5 (e.g., at least 5, 10, 15, 20, 25, 30, 40, 50) avocados (e.g., California avocados, Mexican avocados, or the like, and the avocados can be #84, #70, #60, #48, #40, #36, #32, #28 avocados or the like). For example, the plurality of produce items are treated California #60 avocados (e.g., 30 California #60 avocados), wherein treated California #60 avocados are California #60 avocados that are treated by the produce treatment methods disclosed herein. In some embodiments, wherein the plurality of produce items are 30 treated California #60 avocados, and 5 days after the 30 treated California #60 avocados were treated, the 30 treated California #60 avocados have an average shore value of at least 10 shore, at least 15 shore, at least 20 shore, or at least 25 shore greater than the average shore value of 30 untreated California #60 avocados, and wherein at day 0, the 30 treated California #60 avocados have an average shore value of ±10 shore of the 30 untreated California #60 avocados. As used herein, the term “day 0” refers to the day that the plurality of produce items are treated but prior to the plurality of produce actually being treated.

In some embodiments, following the treatment of an agricultural product by the produce treatment methods disclosed herein, an amount of green mold or blue mold of the agricultural product is deactivated. For example, the treatment of an agricultural product by the produce treatment methods disclosed herein can be used to block the growth of green mold or blue mold (e.g., Botrytis cinerea, Penicillium spp., Monihnia spp., Alternaria alternata, Rhizopus stolonifera, Trichothecium roseum, Fusarium spp., Colletotrichum spp., or any combination thereof).

In some embodiments, following the treatment of an agricultural product by the produce treatment methods disclosed herein, the respiration rate of the agricultural product can be reduced. For example, the treatment of an agricultural product by the produce treatment methods disclosed herein can be used to block or limit diffusion of gasses such as ethylene, CO₂, and O₂, among others, thereby slowing ripening and/or senescence. In some embodiments, following the treatment of an agricultural product by the produce treatment methods disclosed herein, the rate of CO₂ production by the agricultural product is reduced.

Also provided herein is a plurality of produce items coated with the edible coating composition, wherein the edible coating composition comprises a coating agent comprising: one or more monoglycerides; and one or more fatty acid salts; a solvent; and allyl isothiocyanate. The coating agent can be as described above, however, the edible coating composition further comprises allyl isothiocyanate. In some embodiments, the allyl isothiocyanate is present in the edible coating composition in an amount of about 0.001% v/v to about 5% v/v. For example, the allyl isothiocyanate is present in the edible coating composition in an amount of about 0.01% v/v to about 2.5% v/v, or about 0.1% v/v to about 1.5% v/v, or about 0.5% v/v to about 1.5% v/v.

In some embodiments, following the application of the edible coating composition comprising allyl isothiocyanate, an amount of green mold or blue mold of the agricultural product is deactivated. For example, treatment of an the edible coating composition comprising allyl isothiocyanate disclosed herein can be used to block the growth of green mold or blue mold (e.g., Botrytis cinerea, Penicillium spp., Monihnia spp., Alternaria alternata, Rhizopus stolonifera, Trichothecium roseum, Fusarium spp., Colletotrichum spp., or any combination thereof).

In some embodiments, following the application of the edible coating composition the respiration rate of the agricultural product can be reduced. For example, the application of any of the edible coating composition described herein can be used to block or limit diffusion of gasses such as ethylene, CO₂, and O₂, among others, thereby slowing ripening and/or senescence. In some embodiments, following the application of the edible coating composition or emulsion, the rate of CO₂ production by the agricultural product is reduced.

The foregoing description and following examples detail certain specific embodiments of the disclosure and describe the best mode that the inventors contemplated. It will be appreciated, however, that no matter how detailed the foregoing may appear in text, the disclosure may be practiced in many ways, and the disclosure should be construed in accordance with the appended claims and equivalents thereof.

Although the disclosed teachings have been described with reference to various applications, methods, compounds, compositions, and materials, it will be appreciated that various changes and modifications to them may be made without departing from the teachings herein. The following examples are provided to better illustrate the disclosed teachings and are not intended to limit the scope of the teachings presented herein. While the present teachings have been described in terms of these exemplary embodiments, the skilled artisan will readily understand that numerous variations and modifications of these exemplary embodiments are possible without undue experimentation. All such variations and modifications are within the scope of the teachings of this disclosure.

### Examples

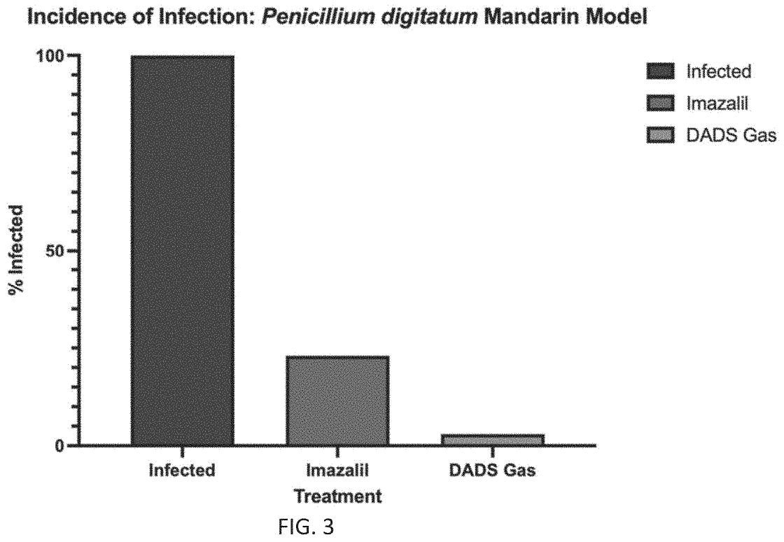

Example 1. The antifungal activity of diallyl disulfide (DADS) vapor against Penicillium digitatum (Pd) was tested in mandarins. All samples were wounded by puncturing with a screw and infected by dispensing 1000 Pd spores suspended in 10 μL of water into each wound. The test groups consisted of mandarins that were: untreated; dipped in a solution of 1 g/L of imazalil; and exposed for 72 hours to the vapor of 3 mL of DADS in a Petri dish. Quantification of the infection shown in FIG. 3 indicates that exposure to DADS vapor reduced the incidence of Pd mold by 95.8% compared to the untreated samples and 19.1% compared to imazalil treated samples. The mandarins that were exposed to DADS vapor showed no visible degradation or discoloration. FIG. 3 shows that passive volatilization of DADS in a closed, unsealed bin substantially prevents Pd mold growth in mandarins.

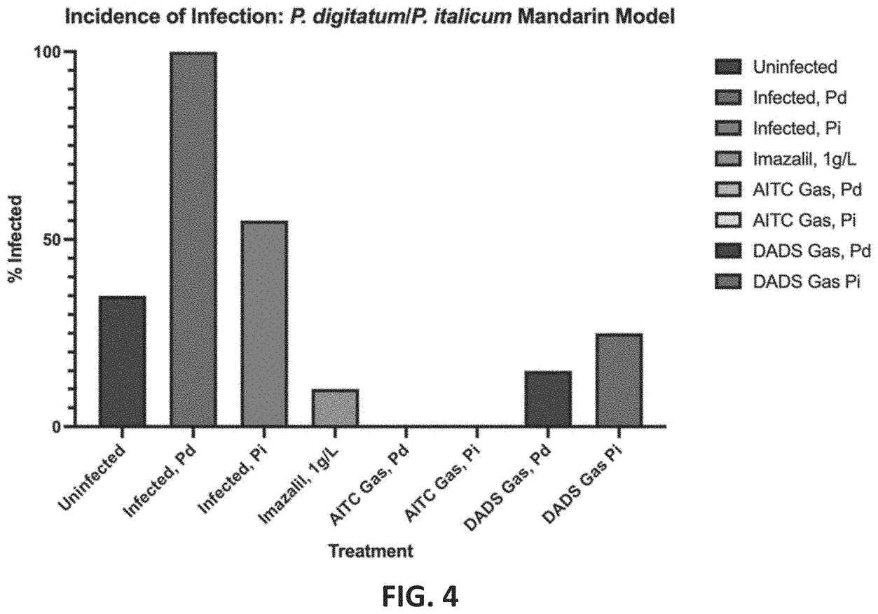

Example 2. The antifungal activity of allyl isothiocyanate (AITC) and DADS vapor was tested against Pd and Penicillium italicum (Pi) in mandarins. All samples were wounded by puncturing with a screw. Mandarins were infected by dispensing either 1000 Pd spores or 1000 Pi spores suspended in 10 μL into the wound. The test groups consisted of mandarins that were: uninfected and untreated; uninfected and treated by dipping in a solution of 1 g/L of imazalil; infected with Pd and untreated; infected with Pd and exposed to AITC; infected with Pd and exposed to DADS; infected with Pi and untreated; infected with Pi and exposed to AITC; and infected with Pi and exposed to DADS. Exposure to AITC or DADS consisted of exposing the mandarins for 72 hours to the vapor of 3 mL of the respective compound dispensed in a Petri dish. FIG. 4 shows quantification of the test results. AITC vapor substantially prevented Pd and Pi infections. Mandarins treated with AITC appeared to be visibly darker than untreated fruit. DADS vapor reduced the incidence of Pd mold by 85% and Pi mold by 30% compared to the respective untreated/infected test groups. No difference in appearance was observed in fruit treated with DADS compared with untreated samples. Both AITC and DADS were effective at preventing fungal growth. The inhibition from AITC was approximately 100%, with some changes in visible appearance.

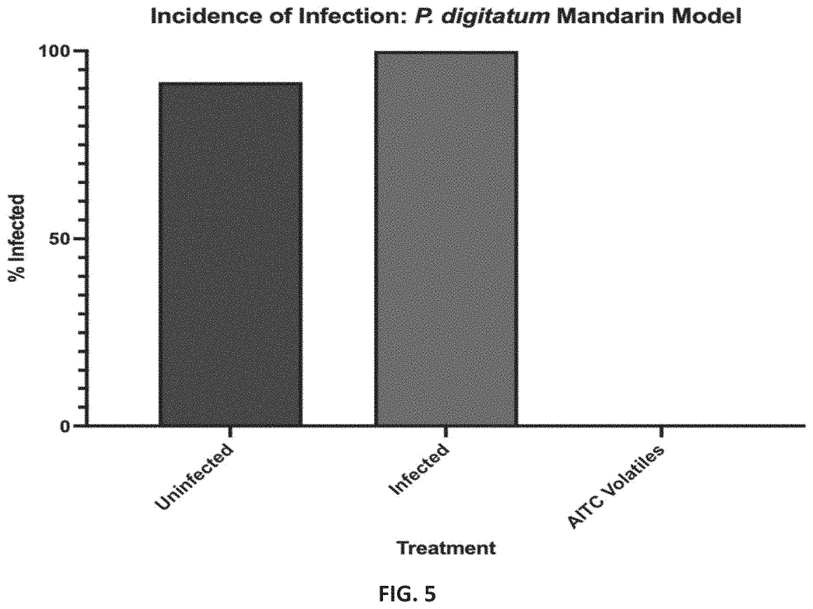

Example 3. The antifungal activity of a reduced dose of AITC vapor against Pd in mandarins was tested. All samples were wounded by puncturing with a screw. Mandarins were infected by dispensing 1000 Pd spores suspended in 10 μL of water into each wound. The test groups consisted of mandarins that were: uninfected and untreated; infected with Pd and untreated; and exposed to the vapor of 500 μL of AITC in a Petri dish for 72 hours. FIG. 5 shows the quantification of the infection of the test groups. The uninfected and untreated group showed a significant infection in the initially uninfected fruit. A dose of AITC that was ⅙ the dose used in Example 2 substantially prevented Pd infections. Spotting and darkening of the peel were observed in some samples of the AITC treated fruit.

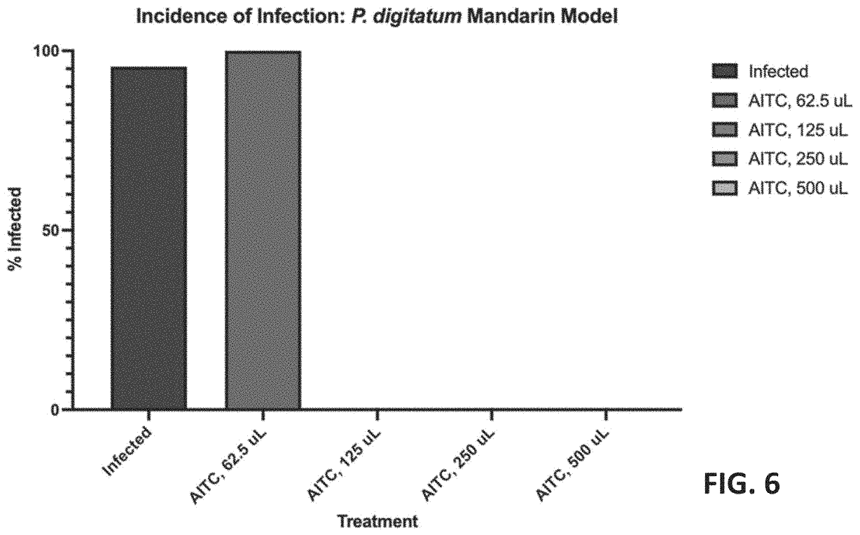

Example 4. The antifungal activity of a range of AITC vapor concentrations was tested against Pd in mandarins. All mandarins were wounded by puncturing with a screw and infected by dispensing 1000 Pd spores suspended in 10 μL of water in each wound. The fruit was then placed in an airtight container, a range of AITC volumes were disposed onto a Whatman filter paper disc, the disc was suspended in front of a battery-powered fan, and the container closed for 18 hours. The mandarins were then left at ambient temperature and high humidity for 6 days. The test groups were mandarins that were infected and untreated, and infected and treated with 62.5 μL 125 μL 250 μL and 500 μL on the filter paper disc. The infection is less severe in the 62.5 μL treatment group than in the control. FIG. 6 is a bar graph showing incidence (% infected) for the test groups. A 62.5 μL dose of AITC reduced the severity of infection relative to the untreated group. Doses of 125 μL 250 μL & 500 μL of AITC substantially prevented the growth mold on the treated mandarins. The 250 μL & 500 μL doses lead to darkening of the peel.

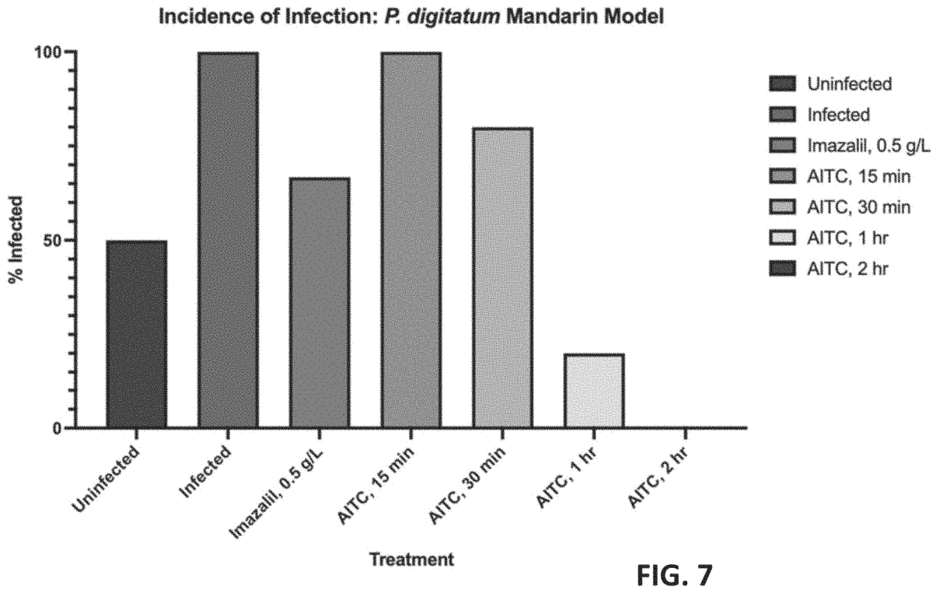

Example 5. The antifungal activity of a range of AITC vapor exposure times was tested to determine the effects against Pd in mandarins. All samples were wounded by puncturing with a screw. Mandarins were infected by dispensing 1000 Pd spores suspended in 10 μL of water in the wound. The fruit was then placed in an airtight container, 125 μL of AITC was dispensed onto a Whatman filter paper disc, the disc suspended in front of a battery-powered fan, and the container closed for 15 minutes to 2 hours. The test groups were then left at ambient temperature, high humidity, and assessed for Pd mold after 6 days. The test groups consisted of mandarins that were: uninfected and untreated; infected and untreated; infected and treated with 0.5 g/L imazalil; infected, treated with 125 μL of AITC on the filter paper, and exposed to the vapor for 15 minutes, 30 minutes, 1 hour, and 2 hours. FIG. 7 shows the quantified infection results. A 15 minute exposure had little effect on Pd mold, a 30 min exposure greatly reduced severity of Pd mold infection, a 1 hour exposure greatly reduced severity and incidence of Pd mold, and a 2 hour exposure substantially eliminated the mold. A non-Pd latent fungal infection confounded results for the imazalil control and the 1 hour AITC treatment. For the 2 hour treatment, spotting and darkening of the peel was observed in 62.5% of the fruit. A 30 minute exposure to an AITC vapor concentration of 730 ppm appeared to either substantially prevent mold infection or reduce the severity of infection. Longer exposure time increased the antifungal efficacy. Latent pathogens, as seen in the 1 hour exposure samples (FIG. 7), are substantially resistant to AITC vapor for this concentration and exposure time. Longer exposure times were effective at largely eliminating these pathogens.

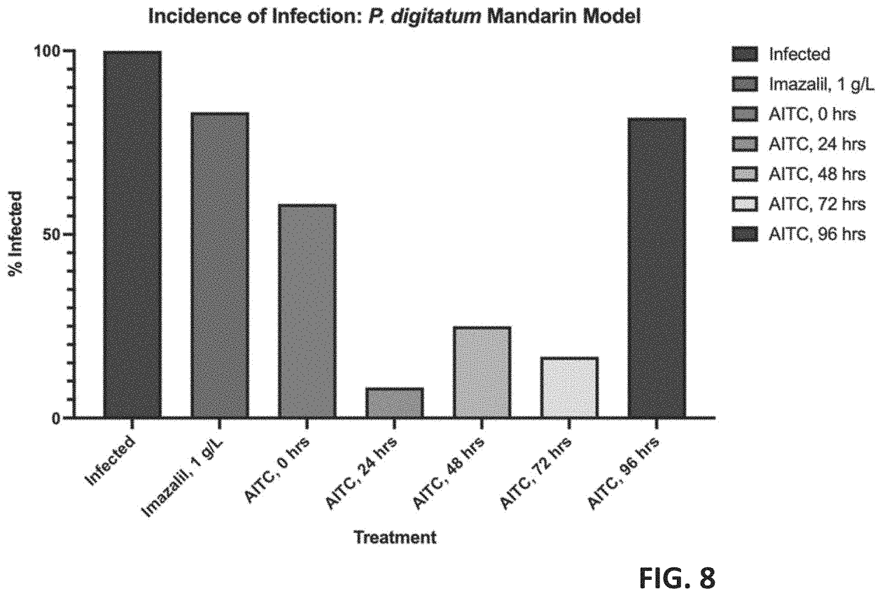

Example 6. The antifungal activity of AITC vapor was measured using a range of incubation times after infection before treatment to test the treatment window against Pd in mandarins. All samples were wounded by puncturing with a screw and infected by dispensing 1000 Pd spores suspended in 10 μL of water in the wound. The mandarins were then incubated for 0 to 4 days prior to treatment. For treatment, the mandarins were placed in an airtight container, 125 μL of AITC was dispensed onto a Whatman filter paper disc, the disc suspended in front of a battery-powered fan, and the container closed for 30 minutes. The test groups were then left at ambient temperature, high humidity, and assessed for Pd mold after 6 days. The test groups consisted of mandarins that were: untreated; treated with 1 g/L of imazalil; and incubated for 0 hours, 24 hours, 48 hours, 72 hours, and 96 hours before treatment with AITC. FIG. 8 shows the quantified infection results. The fruit was of poor quality, with significant rates of latent infection by multiple fungal pathogens (including Penicillium spp.) and 83.3% infected in the imazalil treated group. For those treated with AITC immediately after infection 58.3% were infected. For those treated after 24 hours 8.3% were infected. For those treated after 48 hours 25% were infected. For those treated after 72 hours 16.7% were infected. For those treated after 96 hours, 81.6% were infected. Treating 24 hours after infecting lead to the lowest percentage of Penicillium infection of the test groups. Treating immediately after infection led to the poorest fruit quality of the test treatments. It is not known if this was due to the treatment regime or the initial fruit quality. Intermediate treatment time points showed efficacy against infection.

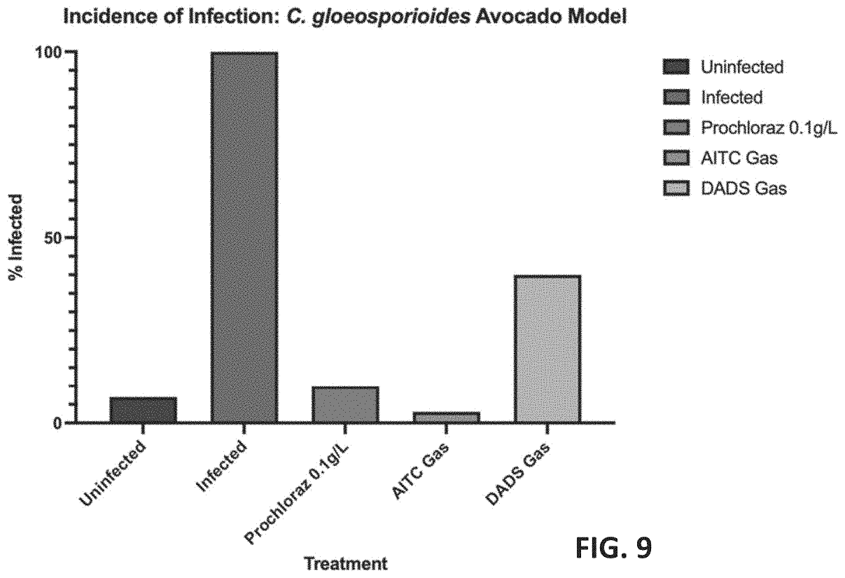

Example 7. The antifungal activity of AITC and DADS vapor against Colletotrichum gloeosporioides (Cg) was tested in avocados. All test pieces were wounded by removing the stem and infected by dispensing 1000 Cg spores suspended in 10 μL of water into the wound. The test groups consisted of avocados that were: untreated and uninfected; untreated and infected; treated by dipping in a solution of 0.1 g/L of prochloraz; exposed to the vapor of 3 mL of AITC disposed in a Petri dish; and exposed to the vapor of 3 mL of DADS disposed in a Petri dish. FIG. 9 quantifies the infection results. AITC vapor reduced the incidence of Cg mold by 97% compared to the untreated test group and 70% compared to the prochloraz treated test group. DADS vapor reduced the incidence of Cg mold by 60% compared to the untreated test group.

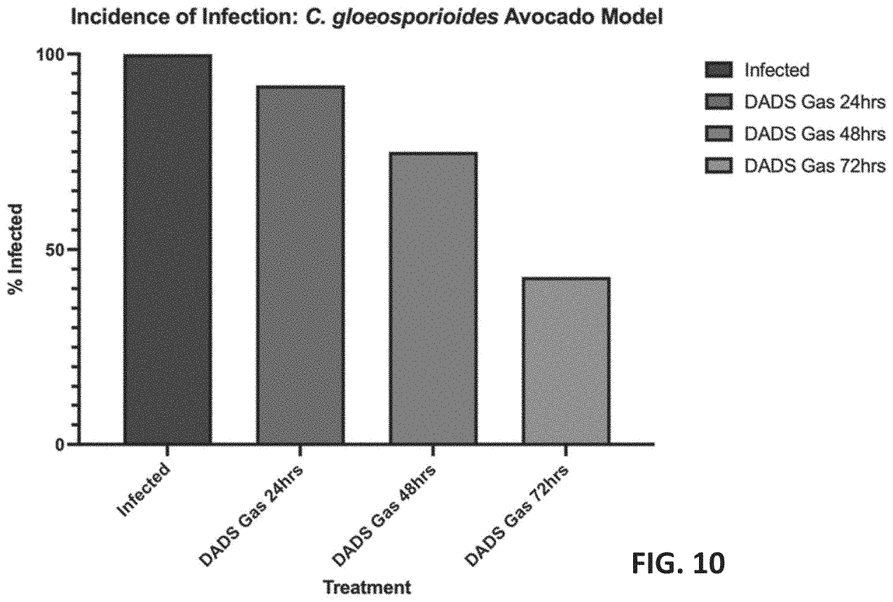

Example 8. The antifungal activity of a range of DADS vapor exposure times was tested against Cg in avocados. All test pieces were wounded by removing the stem and infected by dispensing 1000 Cg spores suspended in 10 μL of water into the wound. The test groups consisted of avocados that were: infected and untreated; and exposed to the vapor of 3 mL of DADS in a Petri dish for 24 hours, 48 hours, and 72 hours. FIG. 10 quantifies the infection results. Test group exposed to DADS vapor at all exposure times reduced the incidence of Cg mold compared to the untreated test group. A 24 hour DADS exposure reduced the incidence of Cg mold by 8%. A 48 hour DADS exposure reduced the incidence of Cg mold by 25%. A 72 hour DADS exposure reduced the incidence of Cg mold by 57%.

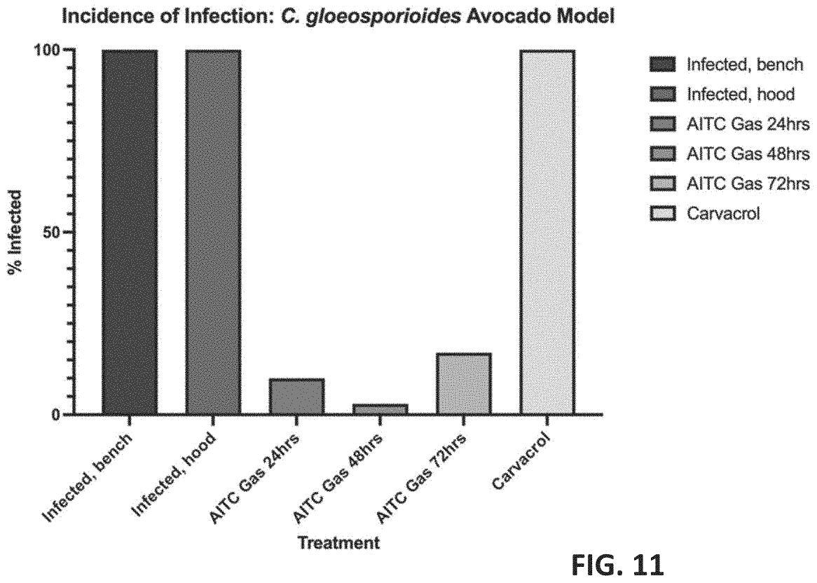

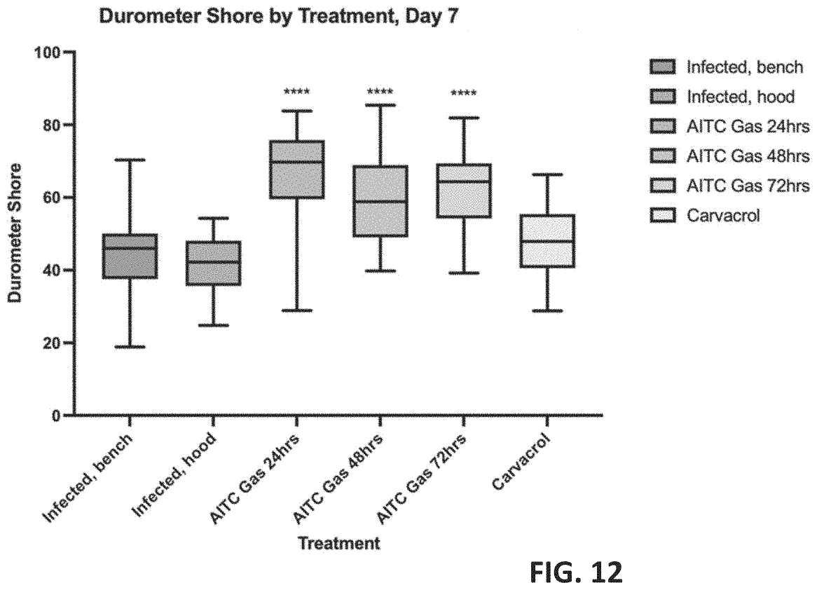

Example 9. The antifungal activity of a range of AITC and carvacrol vapor exposure times was tested against Cg in avocados. To measure the effect of the various treatments on ripening, durometer shore was taken after 7 days of incubation at ambient temperature and high humidity. All samples were wounded by removing the stem and infected by dispensing 1000 Cg spores suspended in 10 μL of water in the wound. The test groups consisted of avocados that were: infected and left untreated on the benchtop; infected and left untreated under a fume hood; exposed to the vapor of 3 mL of AITC in a Petri dish for 24 hours, 48 hours, and 72 hours; and exposed to the vapor of 3 mL of carvacrol in a Petri dish for 72 hours. FIG. 11 quantifies the infection results. FIG. 12 shows the durometer shore results for the test groups. All exposure times to AITC vapor reduced the incidence of Cg mold compared to the untreated samples. A 24 hour AITC exposure reduced the incidence of Cg mold by 90%. A 48 hour AITC exposure reduced the incidence of Cg mold by 97%. A 72 hour AITC exposure reduced the incidence of Cg mold by 83%. Exposure to carvacrol vapor did not reduce the incidence of Cg mold. FIG. 12 shows that all of the AITC treatments had significantly higher shore than the untreated avocados (average increase of 20.3 shore; P value<0.0001).

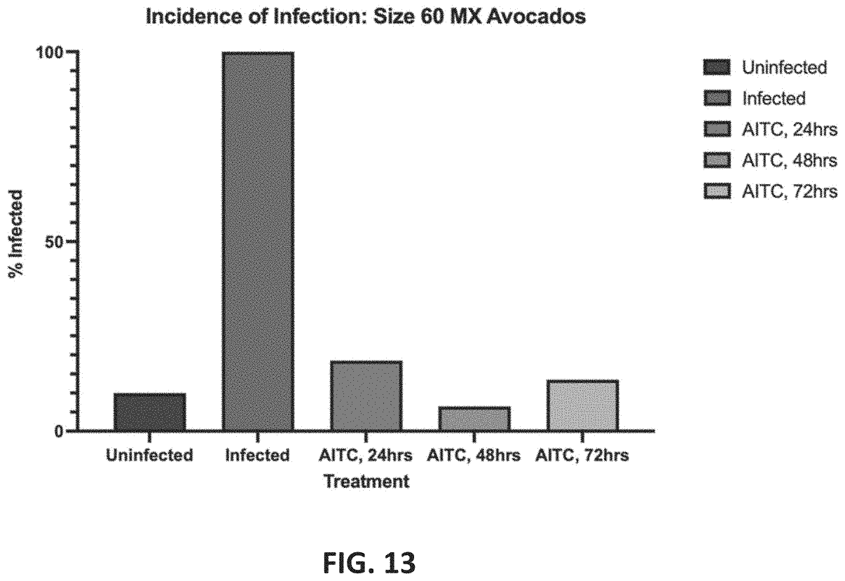

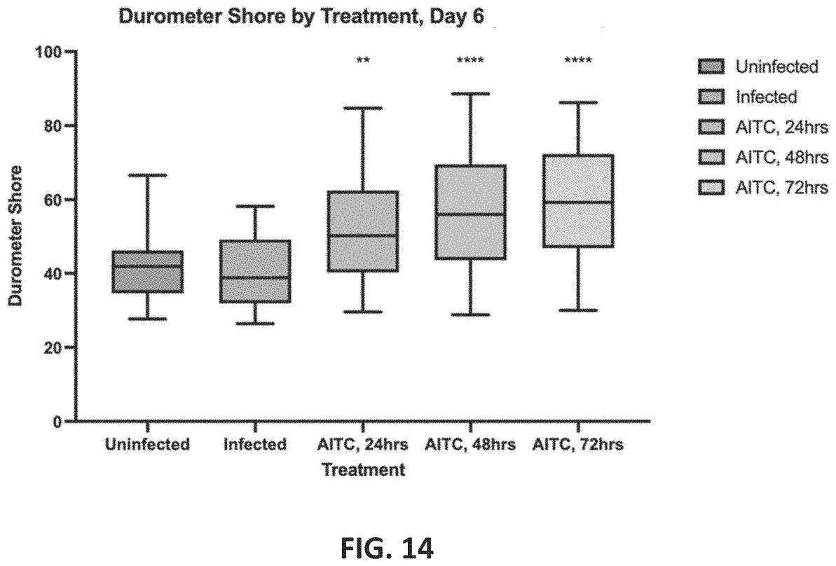

Example 10. The antifungal activity of a range of AITC vapor exposure times were tested against Cg in avocados. To measure the effect of the various treatments on ripening, durometer shore was taken after 6 days of incubation at ambient temperature and high humidity. All samples were wounded by removing the stem and infected by dispensing 1000 Cg spores suspended in 10 μL of water in each wound. The test groups consisted of avocados that were: infected and left untreated on the benchtop; infected and left untreated in a fume hood; exposed to the vapor of 3 mL of AITC in a Petri dish for 24 hours, 48 hours, and 72 hours. FIG. 13 quantifies the infection results. FIG. 14 shows the durometer shore results for the test groups. All exposure times to AITC vapor reduced the incidence of Cg mold compared to the untreated samples. A 24 hour AITC exposure reduced the incidence of Cg mold by 81.5%. A 48 hour AITC exposure reduced the incidence of Cg mold by 93.5%. A 72 hour AITC exposure reduced the incidence of Cg mold by 86.5%. All of the AITC treatments had significantly higher shore than the infected avocados (average increase of 15.4 shore; P value<0.005).

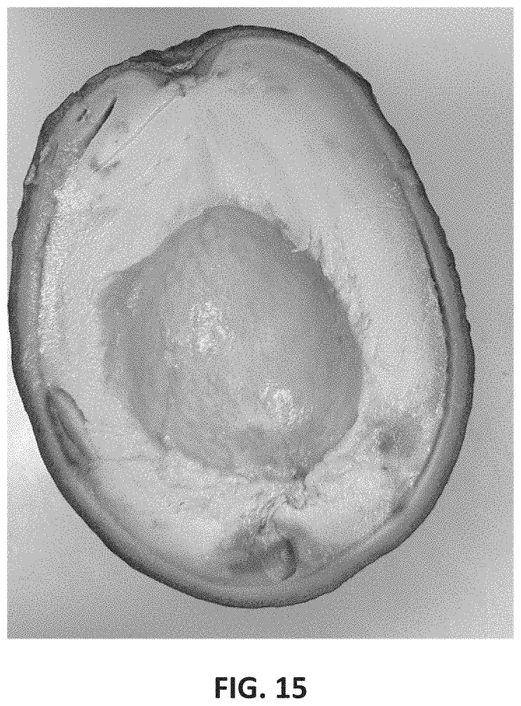

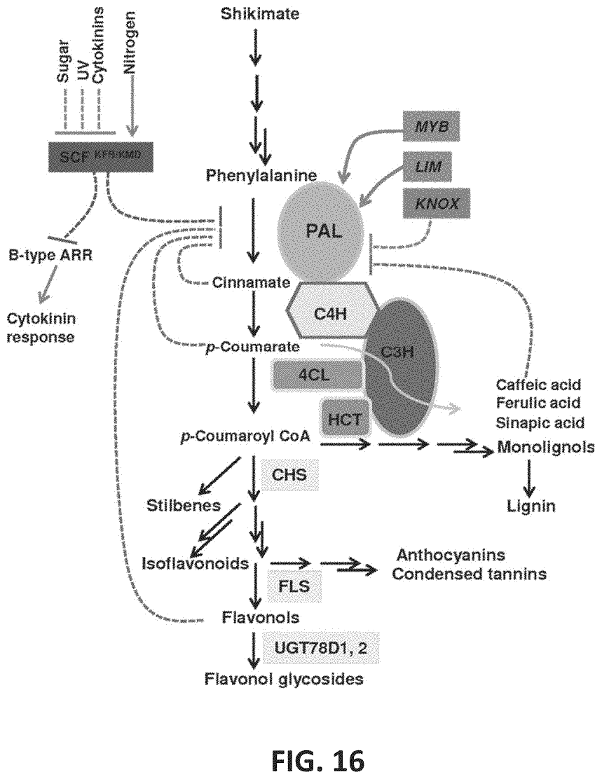

Example 11. The ripening characteristics of avocados exposed to AITC vapor was analyzed. Treatment groups consisted of avocados that were: exposed to the vapor of 125 μL of AITC in a Petri dish for 30 min and 18 hours; exposed to the vapor of 500 μL of AITC for 30 minutes and 18 hours; untreated and kept 18 hours in a bin; and treated with a coating agent. Two sets of the preceding test groups were studied. One set was treated when cold along with coated fruit (i.e., fruit treated with a coating agent (95 wt % glyceryl monostearate and 5 wt % sodium stearate) and another set was treated when warm (one day out of cold storage). Daily measurements were made of respiration and firmness (using a durometer). At the start of the test, the avocados were placed in cold storage. After one day, the cold treated avocados were treated with AITC directly after removal from cold storage. The coated group was treated at this time. The warm treated avocados were allowed to warm to room temperature. On the second day, measurements were begun on the cold treated avocados and AITC treatments began on the warm treated samples. On the third day, measurements began on the warm treated groups. The test groups consisted of avocados that were: untreated; exposed to the vapor of 500 μL of AITC for 18 hours; and exposed to the vapor of 125 μL of AITC for 30 minutes. At the end of the test, the avocados were cut and the halves were imaged full flat below 40 shore. FIG. 15 is an image an avocado half that was exposed to the vapor of 500 μL of AITC. The peel was thicker and the flesh was riper than the durometer indicates in these high level treatment test groups compared with low level treatment groups. FIG. 16 shows a schematic of the enzyme pathway related to a hypothesis for the thickening of the peel. Without being bound by theory, upregulation of defense response pathways may trigger the production of defense compounds and antioxidants (e.g. caffeic acid, ferulic acid, sinapic acid and anthocyanins) including potentially lignin. This upregulation of lignin may cause the peel of the avocado to thicken, which can give the feeling of a firmer fruit while the flesh inside has ripened and softened normally. These results indicate that exposure of the test group to AITC vapor at the 500 μL level causes darkening and thickening of the avocado peel and a prolonged feeling a firmness. The firmness retention is not corroborated by changes in respiration rate that would indicate any changes to fruit ripening or senescence.

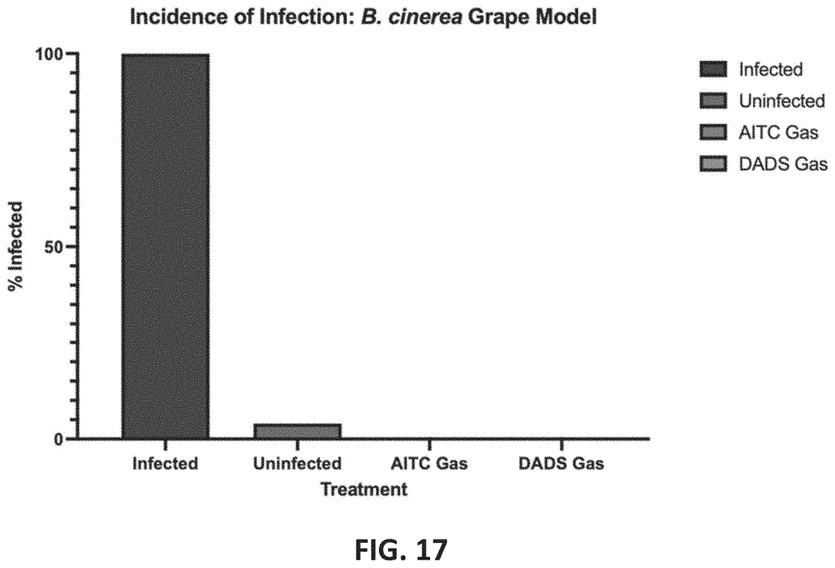

Example 12. The antifungal activity of AITC and DADS vapor against Botrytis cinerea (Bc) in grapes was tested. All samples were wounded by making a 3 mm deep puncture in the skin. Samples were infected by dispensing 1000 Bc spores suspended in 10 μL of water in the wound. The test groups consisted of grapes that were: uninfected and untreated; infected and untreated; exposed to the vapor of 3 mL of AITC in a Petri dish for 72 hours; and exposed to the vapor of 3 mL of DADS in a Petri dish for 72 hours. FIG. 17 quantifies the infection results. Exposure to both AITC and DADS vapor substantially eliminated Bc mold. The grapes exposed to DADS vapor appeared unchanged following incubation, with no visible differences compared with the untreated and uninfected grapes. The grapes exposed to AITC vapor exhibited a darkening of the fruit. Both AITC and DADS vapor were effective at controlling Bc mold. Treatment with AITC can potentially lead to changes in color or flavor of the grapes.

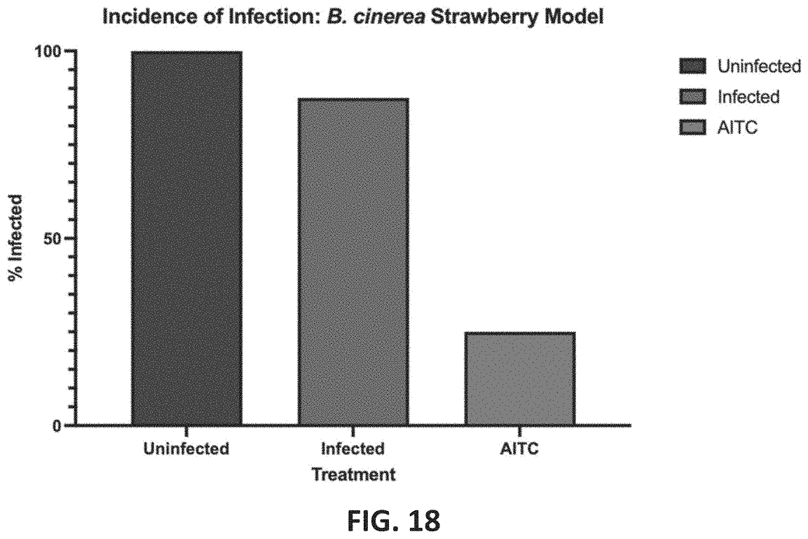

Example 13. The antifungal activity of AITC vapor against Bc in strawberries was tested. All samples were wounded by making a 3 mm deep puncture in the skin. Samples were infected by dispensing 1000 Bc spores suspended in 10 μL of water in the wound. Samples were then incubated at ambient temperature, imaged, and assessed for mold over the following 3 days. The test group consisted of strawberries that were: uninfected and untreated; infected and untreated; and exposed for 30 minutes to the vapor of 125 uL AITC dispensed on Whatman filter paper. After 24 hours, no mold was visible on any of the samples. After 48 hours, % of the uninfected samples showed visible mold, % of the infected samples showed visible mold, and ⅛ of the AITC vapor-treated samples showed visible mold. After 72 hours, ⅞ of the uninfected samples showed visible mold, ⅞ of the infected samples showed visible mold, and ¼ of the AITC vapor treated samples showed visible mold. FIG. 18 shows quantification of the infection results. AITC vapor demonstrated efficacy against Bc mold in strawberries stored at ambient conditions. The infection rates in the initially uninfected sample indicate that the step involving the initial infection of the wound by dispensing the Bc spores may not be necessary to promote infection in the test groups.

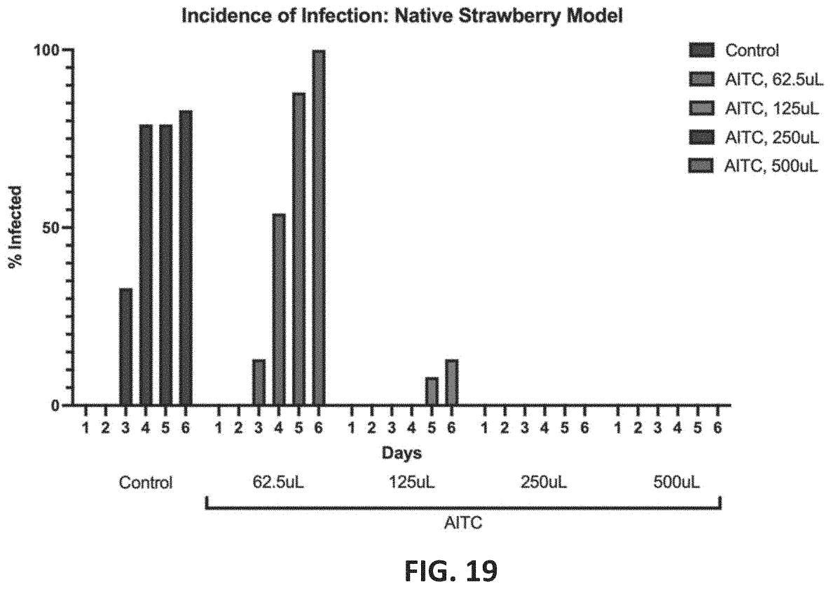

Example 14. The antifungal activity of a range of AITC vapor concentrations against Bc in strawberries was tested. Samples were treated by exposure for 30 minutes to the vapor of a range of volumes of AITC disposed on a filter paper disc, then incubated at ambient temperature, imaged, and assessed for mold over the following 6 days. Test groups consisted of strawberries that were untreated and strawberries exposed to the vapor of 62.5 μL, 125 μL, 250 μL, and 500 μL of AITC. FIG. 19 shows quantification of the infection results. On day 6, 83% of the untreated control strawberries were infected, 100% of the 62.5 μL AITC dose strawberries were infected, 13% of the 125 μL AITC dose strawberries were infected, and 0% of the 250 and 500 μL AITC dose strawberries were infected. For strawberries incubated at room temperature, all of the AITC doses above 62.5 μL were effective at preventing mold, with doses above 125 μL substantially eliminating mold.

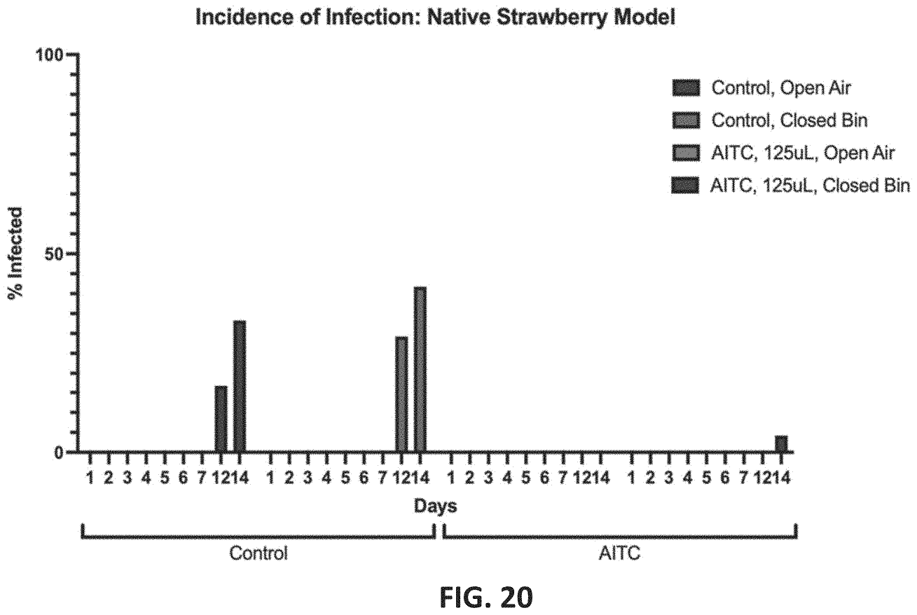

Example 15. The antifungal activity of AITC vapor under different exposure conditions against Bc in strawberries was tested. Test groups consisted of strawberries that were untreated and treated by exposure for 30 minutes to the vapor of 125 μL of AITC disposed on a filter paper disc. Test groups were then incubated in either open or closed containers at 4° C., imaged, and assessed for mold over the following 14 days. FIG. 20 shows quantification of the infection results. All samples were free of mold through 7 days. On day 12, 16.7% of the open air controls were infected, 29.2% of closed container controls were infected, and 0% of the AITC treated were infected. On day 14, 33.3% of the open air controls were infected, 41.7% of closed container controls were infected, 0% of the open air AITC treated were infected, and 4.2% of the closed container AITC treated were infected. For strawberries incubated at 4° C., AITC treatment was effective in reducing the incidence of mold over a two week period. While ⅓ of the open air untreated samples were infected, none of the open air AITC-treated were infected. Over 40% of the closed container controls were infected. A single strawberry was infected in the closed container AITC-treated test group.

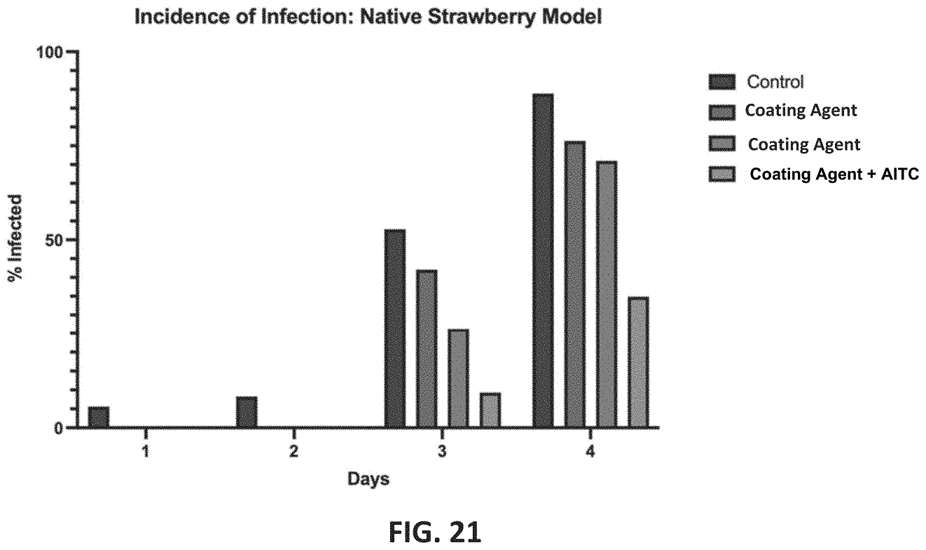

Example 16. The antifungal activity of AITC vapor against Bc in strawberries treated with a coating agent (95 wt % glyceryl monostearate and 5 wt % sodium stearate) and exposed to vapor in clamshells was tested. Test groups consisted of strawberries that were: untreated; dipped in 40 g/L solution of the coating agent; exposed for 30 minutes to the vapor of 125 μL of AITC disposed on a filter paper disc; and dipped in 40 g/L solution of the coating agent and exposed for 30 minutes to the vapor of 125 μL of AITC disposed on a filter paper disc. Samples were treated, incubated at ambient temperature, imaged, and assessed for mold over the following 4 days. FIG. 21 shows quantification of the infection results. On day 3, 52.8% of the controls were infected, 42.1% of the coating agent were infected, 26.3% of the AITC were infected, and 9.3% of the coating agent+AITC were infected. On day 4, 88.9% of the controls were infected, 76.3% of the coating agent were infected, 71% of the AITC were infected, and 34.9% of the coating agent+AITC were infected. Exposing the strawberries to AITC vapor in clamshells was less effective than exposing the strawberries in a more spread out manner as was done in previous examples. Bowl dipping in the coating solution also presented challenges for drying around the calyx. Both AITC-treated and coating agent+AITC-treated strawberries had a significantly lower incidence of mold compared to the untreated group.

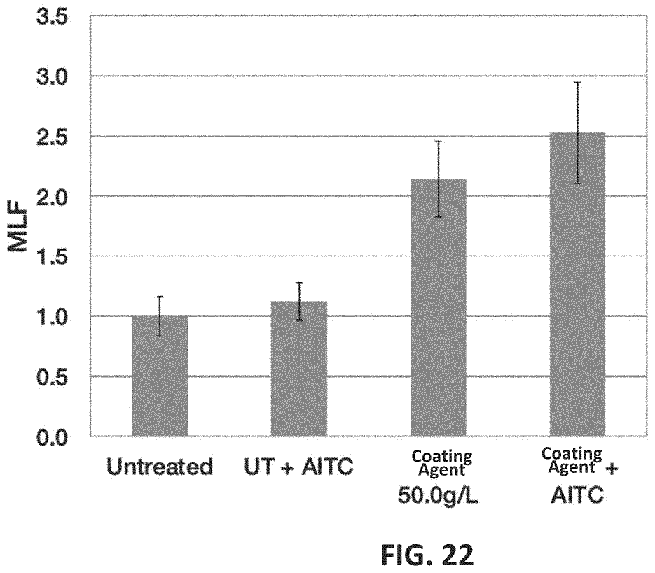

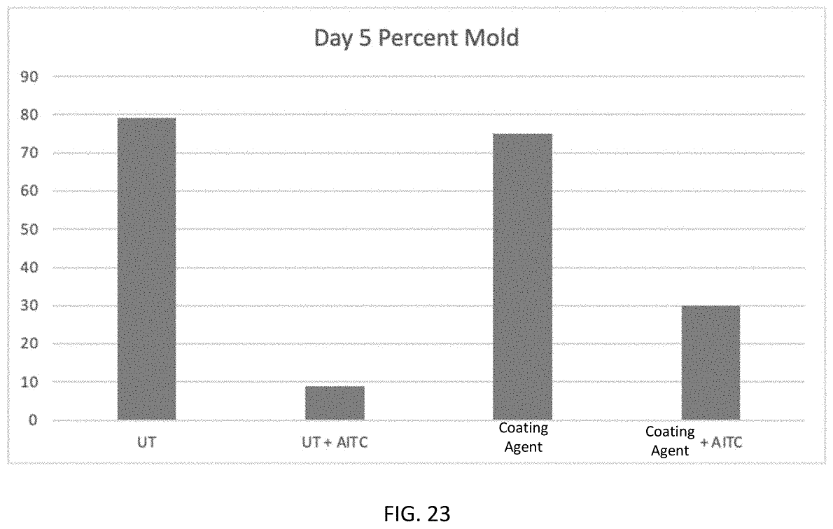

Example 17. The antifungal activity of AITC vapor against Bc in strawberries treated with the coating agent and suspended was tested. Test groups consisted of strawberries that were: untreated; suspended and dipped in 50 g/L solution of the coating agent; exposed for 30 minutes to the vapor of 125 μL of AITC disposed on a filter paper disc; suspended and dipped in 50 g/L solution of the coating agent and exposed for 30 minutes to the vapor of 125 μL of AITC disposed on a filter paper disc. Samples were suspended, treated, incubated at ambient temperature, imaged, and assessed for mold over the following 5 days. FIG. 22 is a plot the Mass Loss Factor (MLF) of the test groups. % Mass Loss Rate (% MLR) is the percentage of mass loss for a group of produce relative to itself per day. Mass Loss Factor (MLF) is the ratio of the untreated % MLR to the treated (e.g., with the coating agent) % MLR. FIG. 23 is a plot of the percent mold measured for the test groups. Suspending the strawberries for treatment and incubation reduced pooling under the calyx and improved drying overall relative to unsuspended conditions. Fruit treated with the coating agent and the coating agent+AITC had significantly higher MLFs compared to controls. By day 5, both AITC and the coating agent+AITC-treated strawberries had significantly less mold than the untreated test group, with reductions in incidence of over 80% and 60% respectively. Firmness measurements indicate that all treated strawberries had improved firmness relative to the untreated test group. Time lapse videos showed that both coating agent-treated test groups had better color retention and less shrinkage than the other test groups. The coating agent only treated test group had some signs of mold on day 5. No mold was observed on the coating agent+AITC treated test group.

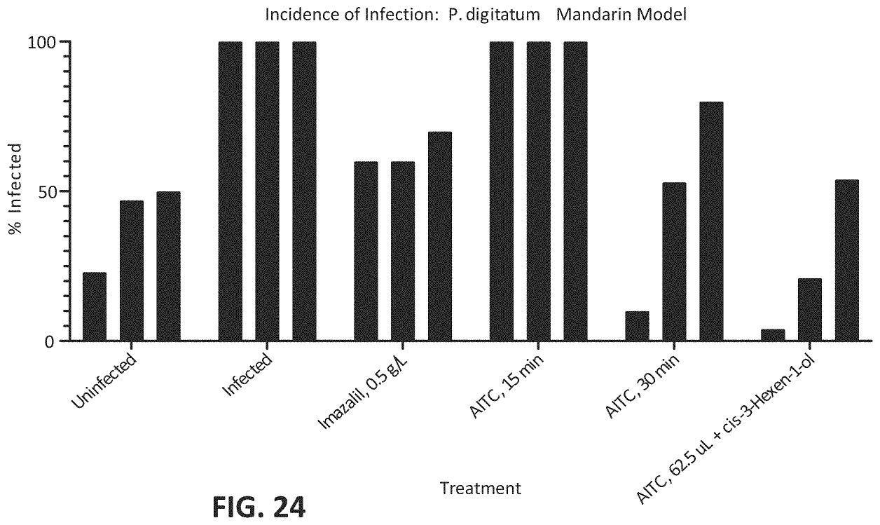

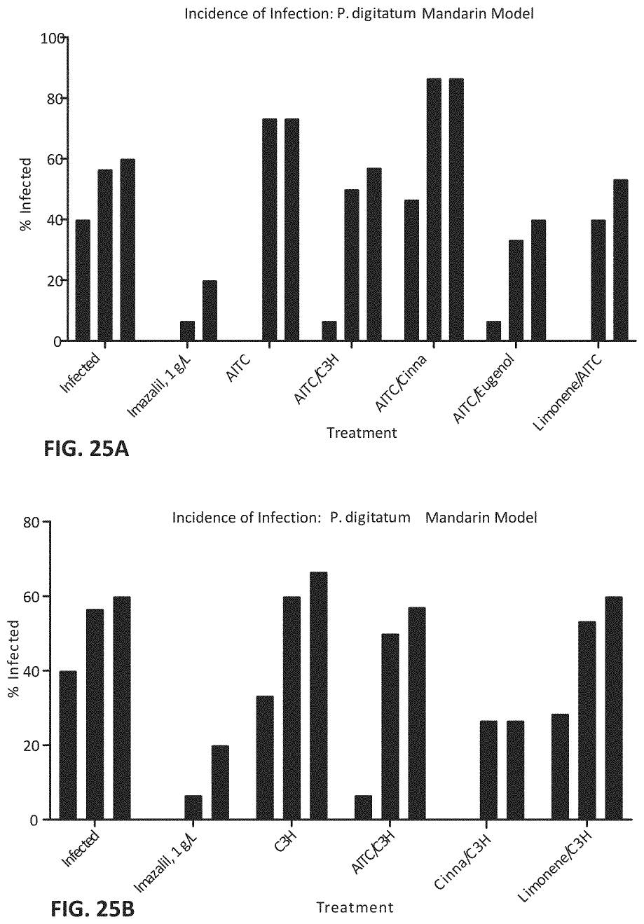

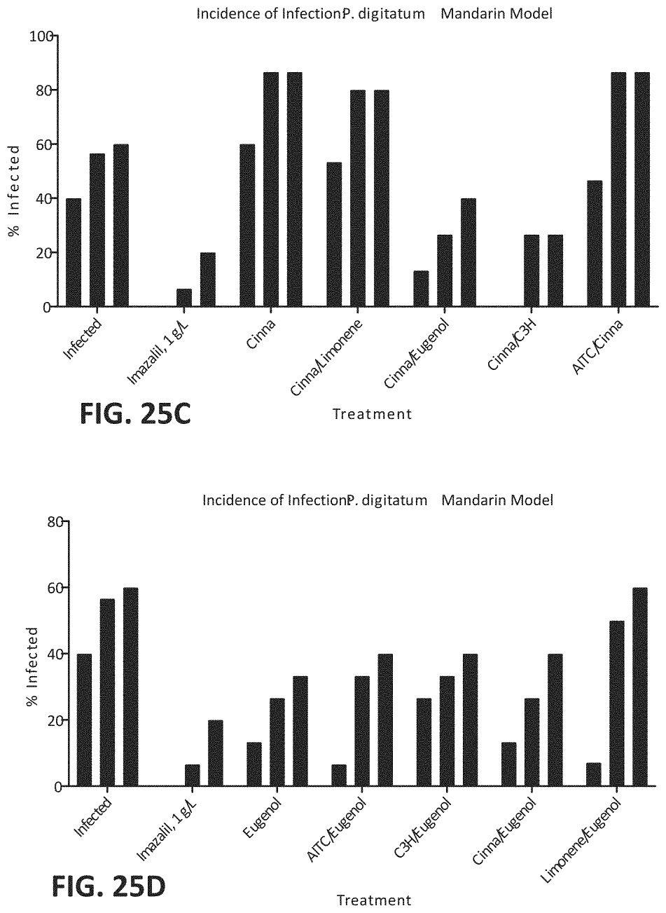

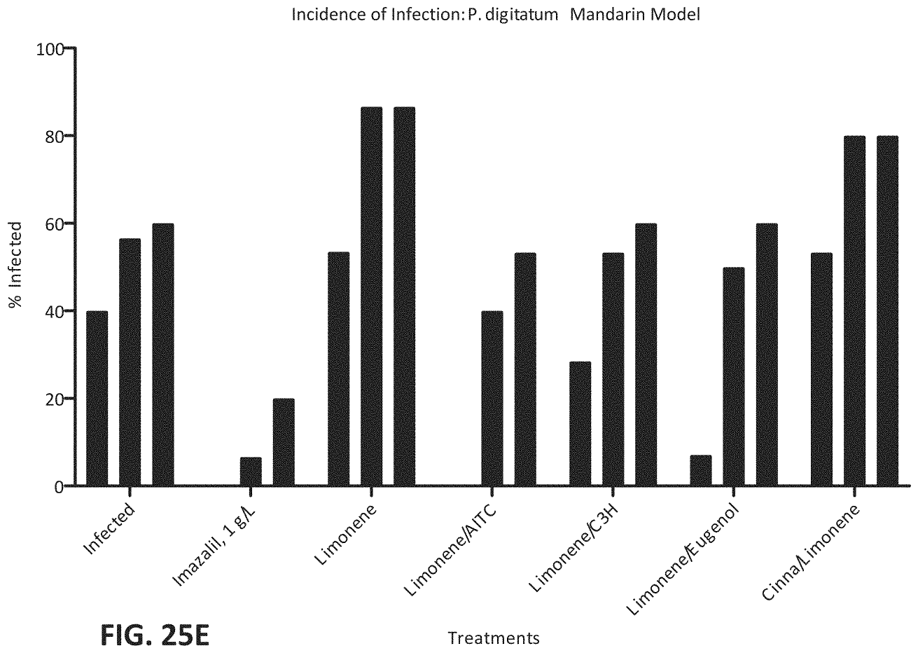

Example 18. The antifungal activity of AITC in combination with cis-3-hexen-1-ol (c3H) vapor against Pd in mandarins was tested. All samples were wounded by puncturing with a screw. Samples were infected by dispensing 1000 Pd spores suspended in 10 μL of water in the wound. Exposure to vapor was done by placing the mandarins in an airtight container, dispensing AITC or AITC+c3H onto Whatman filter paper discs, suspending the discs in front of a battery-powered fan, closing the container and incubating the mandarins for 30 minutes. After vapor exposure, the mandarins were left at ambient temperature, high humidity, and assessed for Pd mold on days 4-7. Test groups consisted of mandarins that were: uninfected and untreated; infected and untreated; infected and treated by dipping in a solution of 0.5 g/mL imazalil; exposed to the vapor of 125 μL AITC for 15 minutes to 30 minutes; exposed to the vapor of 62.5 μL AITC and 125 μL c3H for 30 minutes. Images were taken of the untreated/infected, AITC-treated, and AITC+c3H test groups on day 5. Images were taken of the untreated/infected, AITC-treated, and AITC+c3H test groups on day 6. Images were taken of the untreated/infected, AITC-treated, and AITC+c3H test groups on day 7. FIG. 24 shows the quantification of the infection results. A 62.5 μL dose of AITC (50% of the standard dose) applied with c3H resulted in a lower infection percentage than full strength doses of AITC alone. The AITC+c3H reduced the incidence and severity of infection relative to the other treatments.

Example 19. The antifungal activity of AITC in combination with c3H and essential oil vapor was tested against Pd in mandarins. All samples were wounded by puncturing with a screw and infected by dispensing 1000 Pd spores suspended in 10 μL of water in the wound. Exposure to vapor was done by placing the mandarins in an airtight container, dispensing the compounds onto Whatman filter paper discs, suspending the discs in front of a battery-powered fan, closing the container and incubating the mandarins for 30 minutes. After vapor exposure, the mandarins were left at ambient temperature, high humidity, and assessed for Pd mold after 6 days. Test groups that were not exposed to vapor consisted of mandarins that were untreated and treated by dipping in a solution of 1.0 g/mL imazalil. The remaining test groups were exposed to the vapor of 62.5 μL AITC and/or 125 μL of all other compounds for 30 minutes. The compounds tested alone or in combinations were AITC, c3H, cinnamadelhyde, eugenol, and limonene. FIGS. 44A-44E show the quantification of the infection results. AITC vapor was applied at 50% of the minimum inhibitory concentration to detect synergy with any of the other tested essential oils. At this lower dose, AITC tends to reduce the severity of infection, but not eliminate the incidence of infection, leaving room for improvement. Of the 15 test treatments, 8 performed better than the untreated samples. These treatments were: AITC+c3H; AITC+eugenol; AITC+limonene; cinnamadelhyde+c3H; cinnamadelhyde+eugenol; eugenol; eugenol+c3H; and eugenol+cinnamadelhyde.

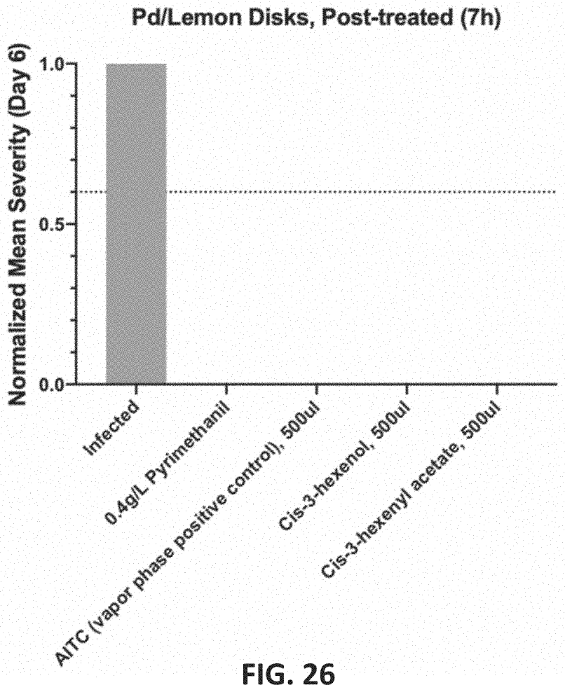

Example 20. The antifungal activity of AITC, c3H and cis-3-hexenyl acetate was tested against Pd in lemons. The test groups consisted of lemon discs that were: untreated; exposed to the vapor of AITC; exposed to the vapor of c3H; and exposed to the vapor of cis-3-hexenyl acetate. The results of the severity of the infections in the samples are quantified in FIG. 26.

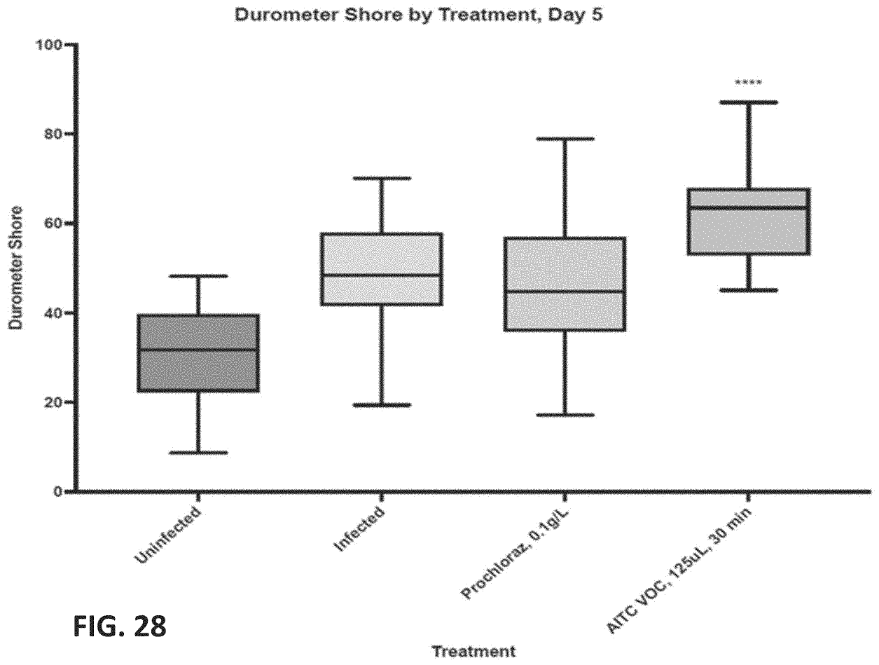

Example 21. The antifungal activity of avocados exposed to AITC vapor and prochloraz was tested against Cg in avocados. To measure the effect of the various treatments on ripening, durometer shore was taken after 5 days of incubation at ambient temperature (about 20° C. to about 25° C.) and high humidity (about 88% relative humidity to about 93% relative humidity). All samples were wounded by removing the stem and infected by dispensing 1000 Cg spores suspended in 10 μL of water in the wound. Exposure to vapor was done by placing the avocados in an airtight container, dispensing AITC onto Whatman filter paper discs, suspending the discs in front of a battery-powered fan, closing the container and incubating the avocados for 30 minutes. After vapor exposure, the avocados were left at ambient temperature, high humidity, and assessed for Cg mold on day 5. Treatment groups consisted of avocados that were: exposed for 30 minutes to the vapor of 125 μL of AITC disposed on a filter paper disc; dipped in a solution of 0.1 g/L of prochloraz and placed to dry on a rack in front of a fan for 30 min; infected and left untreated; and uninfected and untreated. FIG. 28 shows the durometer shore results for the test groups. To prepare the 0.1 g/L of prochloraz, 10 mg of prochloraz was mixed with 10 mL of ethanol and 90 mL of water. The AITC vapor reduced the incidence of Cg mold compared to the untreated samples and the prochloraz treated sample. A 24 hour AITC exposure reduced the incidence of Cg mold by 90%. FIG. 28 shows that the AITC treatment had significantly higher shore than the untreated avocados more than 30 shore. The mean shore value for the untreated avocados was 28.8 (standard deviation (SD)=10.8). The mean shore value for the infected avocados was 47.3 (SD=11.8). The mean shore value of the positive control, prochloraz treated avocados was 44.3 (SD=14.7). The mean shore value of the AITC treated avocados was 61.1 (SD=10.5).

Durometer Shore Measurement: A Fruit Hardness Tester— HPE III Fff w/Sphere Ø 5.0 mm Test Anvil is used for the measurements. The Operating Procedure is as follows:
1) At room temperature and 1 atm pressure, switch on the measuring device and press the hull or sleeve against the specimen so that the contact surface of the pressure plate rests on the fruit. Make sure the pressure applied to the fruit is sufficient, but not so much that damage is done to the fruit when the hull is pressed down.
2) Results obtained are more reliable if the surface of the fruit skin or peel is even. 3) The measuring time begins as soon as the durometer is placed on the sample. The display flashes during measurement.
4) The measuring device is held on the fruit until the beep is heard. The measured value is recorded as the durometer shore of the fruit.

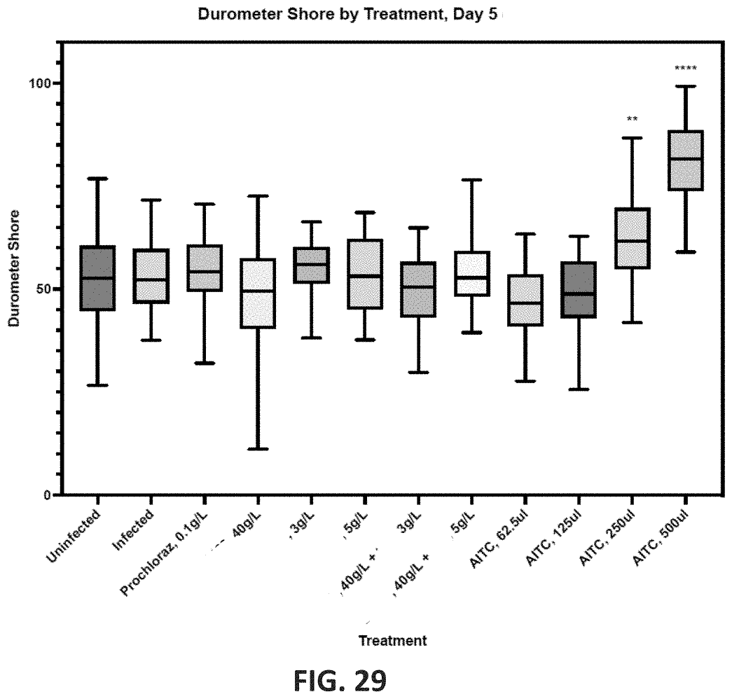

Example 22. The antifungal activity of avocados exposed to AITC vapor, prochloraz, a coating agent (95 wt % glyceryl monostearate and 5 wt % sodium stearate), a coating agent (95 wt % glyceryl monostearate and 5 wt % sodium stearate) with glycerol monodecanoate, and glycerol monodecanoate was tested against Cg in avocados. To measure the effect of the various treatments on ripening, durometer shore was taken after 5 days of incubation at ambient temperature (about 20° C. to about 25° C.) and high humidity (about 88% relative humidity to about 93% relative humidity). All samples were wounded by removing the stem and infected by dispensing 1000 Cg spores suspended in 10 μL of water in the wound. Exposure to vapor was done by placing the avocados in an airtight container, dispensing AITC onto Whatman filter paper discs, suspending the discs in front of a battery-powered fan, closing the container and incubating the avocados for 30 minutes. After vapor exposure, the avocados were left at ambient temperature, high humidity, and assessed for Cg mold on day 5. Treatment groups consisted of avocados that were: uninfected and untreated; infected and untreated; dipped in a solution of 0.1 g/L of prochloraz and placed to dry on a rack in front of a fan for 30 min; dipped in 40 g/L solution of the coating agent; dipped in 3 g/L solution of glycerol monodecanoate; dipped in 5 g/L solution of glycerol monodecanoate; dipped in 40 g/L solution of the coating agent and 3 g/L solution of glycerol monodecanoate; dipped in 40 g/L solution of the coating agent and 5 g/L solution of glycerol monodecanoate; exposed for 30 minutes to the vapor of 125 μL of AITC disposed on a filter paper disc; exposed for 30 minutes to the vapor of 62.5 μL of AITC disposed on a filter paper disc; exposed for 30 minutes to the vapor of 125 μL of AITC disposed on a filter paper disc; exposed for 30 minutes to the vapor of 250 μL of AITC disposed on a filter paper disc; and exposed for 30 minutes to the vapor of 500 μL of AITC disposed on a filter paper disc. FIG. 29 shows the durometer shore results for the test groups. The AITC vapor reduced the incidence of Cg mold compared to the untreated samples, the samples treated with coating agent, and the prochloraz treated sample. FIG. 29 shows that the AITC treatment (250 μL) had significantly higher shore than the uninfected and untreated avocados (average increase of about 10 shore; P value=0.0016). FIG. 29 shows that the AITC treatment (500 μL) had significantly higher shore than the uninfected and untreated avocados (average increase of about 28.5 shore; P value<0.0001).

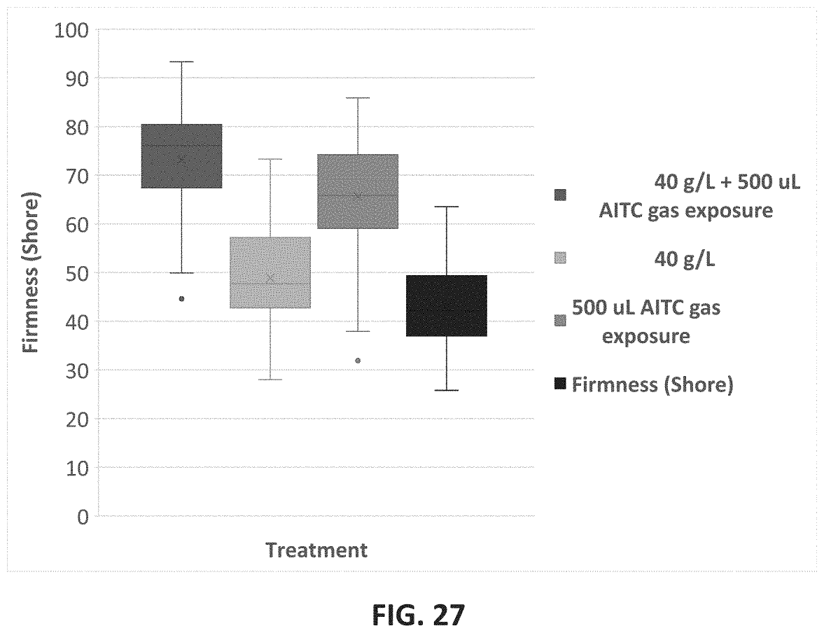

Example 23: The ripening characteristics of avocados exposed to AITC vapor, a coating agent (95 wt % glyceryl monostearate and 5 wt % sodium stearate), and AITC plus the coating agent was analyzed. To measure the effect of the various treatments on ripening, durometer shore was taken after 11 days of incubation at ambient temperature (about 20° C. to about 25° C.) and high humidity (about 88% relative humidity to about 93% relative humidity). Exposure to vapor was done by placing the avocados in an airtight container, dispensing AITC onto Whatman filter paper discs, suspending the discs in front of a battery-powered fan, closing the container and incubating the avocados for 72 hours. Treatment groups consisted of avocados that were: untreated; dipped in 40 g/L solution of the coating agent; exposed for 30 minutes to the vapor of 500 μL of AITC disposed on a filter paper disc; and dipped in 40 g/L solution of the coating agent, dried, and exposed for 72 hours to the vapor of 500 μL of AITC disposed on a filter paper disc. FIG. 27 shows the durometer shore results for the test groups. The AITC vapor treated avocados were of higher quality and had fewer defects than the untreated avocados and the avocados treated with the coating agent alone. FIG. 27 shows that the AITC treatment plus the coating agent test group and the AITC treatment test group had significantly higher shore than the untreated avocados (average increase of 30 shore and 22.5 shore, respectively; P value<0.0001). FIG. 27 shows that the coating agent test group had a slightly higher shore than the untreated avocados (average increase of 5.8 shore; P value<0.0001).

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

1. A produce treatment method comprising:
providing an antimicrobial agent to an enclosure comprising a plurality of produce items; and
contacting the plurality of produce items with the antimicrobial agent, wherein the antimicrobial agent is in gaseous form and is selected to deactivate latent microbes in the plurality of produce items.

2-6. (canceled)

7. The method of claim 1, wherein the enclosure is airtight or limits a rate of diffusion of gas into or out of the enclosure.

8. The method of claim 1, wherein providing the antimicrobial agent to the enclosure comprises providing a gaseous stream comprising the antimicrobial agent to the enclosure.

9. (canceled)

10. The method of claim 1, wherein the length of time is in a range of 1 minute and 100 hours.

11-12. (canceled)

13. The method of claim 1, further comprising volatilizing an antimicrobial agent precursor to yield the antimicrobial agent.

14-15. (canceled)

16. The method of claim 1, further comprising activating an antimicrobial agent precursor to yield the antimicrobial agent.

17. The method of claim 16, wherein activating the antimicrobial agent precursor comprises contacting the antimicrobial agent precursor with a catalyst selected to facilitate conversion of the antimicrobial agent precursor to antimicrobial agent.

18-27. (canceled)

28. The method of claim 1, wherein contacting the plurality of produce items with the antimicrobial agent comprises permeating a cuticular layer of each of the plurality of produce items with the antimicrobial agent.

29. The method of claim 1, wherein the antimicrobial agent comprises one or more of an antibacterial agent, an antifungal agent, and an antiviral agent.

30-33. (canceled)

34. The method of claim 29, wherein the antifungal agent is selected to deactivate green mold or blue mold.

35. The method of claim 29, wherein the antifungal agent is selected to deactivate Botrytis cinerea, Penicillium spp., Monilinia spp., Alternaria alternata, Rhizopus stolonifera, Trichothecium roseum, Fusarium spp., Colletotrichum spp., or any combination thereof.

36. The method of claim 1, wherein the plurality of produce items comprises fruits, vegetables, or a combination thereof.

37-40. (canceled)

41. The method of claim 1, wherein the antimicrobial agent comprises allyl isothiocyanate.

42. The method of claim 1, wherein the antimicrobial agent comprises allyl isothiocyanate and one or more antimicrobial agents selected from the group of diallyl disulfide, carvacrol, eugenol, cinnamaldehyde, limonene, thymol, methyl anthranilate, methyl cinnamate, gamma-decalactone, alpha-terpineol, and linalool.

43. The method of claim 1, wherein the antimicrobial agent is provided in a concentration to the enclosure in a headspace at least about 1200 ppmv, at least about 1250 ppmv, or about 1250 ppmv to about 5000 ppmv, or about 1250 ppmv to about 4900 ppmv.

44. (canceled)

45. The method of claim 1, further comprising coating the plurality of produce items with an edible coating composition.

46. The method of claim 45, wherein the edible coating composition comprises:
a coating agent comprising one or more saturated glycerides selected from monoglycerides and diglycerides; and one or more fatty acid salts; and
a solvent.

47-53. (canceled)

54. A produce treatment system comprising:
a reactor configured to facilitate conversion of an antimicrobial agent precursor to an antimicrobial agent, wherein the reactor comprises:
a bed configured to contain particulate media to which a catalyst is coupled, wherein the catalyst is selected to facilitate conversion of the antimicrobial agent precursor to the antimicrobial agent;
an inlet proximate a first end of the bed and configured to direct a carrier gas from a first end of the bed to a second end of the bed;
an additional inlet configured to direct the antimicrobial agent precursor to the bed; and
an outlet proximate a second end of the bed and configured to allow egress of a gaseous mixture comprising the carrier gas and the antimicrobial agent; and
an enclosure fluidly coupled to the reactor through the outlet, wherein the enclosure is configured to accept a plurality of produce items and to contain the gaseous mixture in contact with the plurality of produce items.

55-58. (canceled)

59. A plurality of produce items treated by the method of claim 1.

60-62. (canceled)

63. A method of improving shelf-life of a plurality of produce items, the method comprising: providing an antimicrobial agent to an enclosure comprising a plurality of produce items; and
contacting the plurality of produce items with the antimicrobial agent, wherein the antimicrobial agent is in gaseous form and is selected to deactivate latent microbes in the plurality of produce items.

64-79. (canceled)
